(19) United States
(12) Patent Application Publication
(10) Pub. No.: US 2026/0167823 A1
(43) Pub. Date: Jun. 18, 2026

(54) RESIN COMPOSITION AND ARTICLE MANUFACTURED USING THE SAME

(71) Applicant: Elite Material Co., Ltd., Taoyuan City (TW)

(72) Inventors: Yu-Te LIN, Taoyuan City (TW); Yi-Cheng LIN, Taoyuan City (TW); Sin-Lin DU, Taoyuan City (TW)

(21) Appl. No.: 19/182,700

(22) Filed: Apr. 18, 2025

(30) Foreign Application Priority Data
Dec. 17, 2024 (TW) 113149097

(51) Int. Cl. C08L 79/08; C08J 5/24; C08K 3/36; C08K 5/3445; C08K 7/26; C08K 9/06

(52) U.S. Cl. CPC C08L 79/08; C08J 5/244; C08K 3/36; C08K 5/3445; C08K 7/26; C08K 9/06; C08J 2379/08; C08J 2451/04; C08J 2471/12; C08J 2479/08; C08J 2483/07; C08L 2203/20; C08L 2205/025; C08L 2205/035

(57) ABSTRACT

A resin composition includes: 100 parts by weight of a maleimide resin including 50 parts by weight to 100 parts by weight of a maleimide resin represented by Formula (1); 2 parts by weight to 30 parts by weight of a polymer, including a structural unit represented by Formula (2), a structural unit represented by Formula (5), a structural unit represented by Formula (3) and a structural unit represented by Formula (4), wherein the structural units represented by Formula (3) and Formula (4) are located between the structural unit represented by Formula (2) and the structural unit represented by Formula (5); and 0.5 parts by weight to 5 parts by weight of a silicon-containing compound;

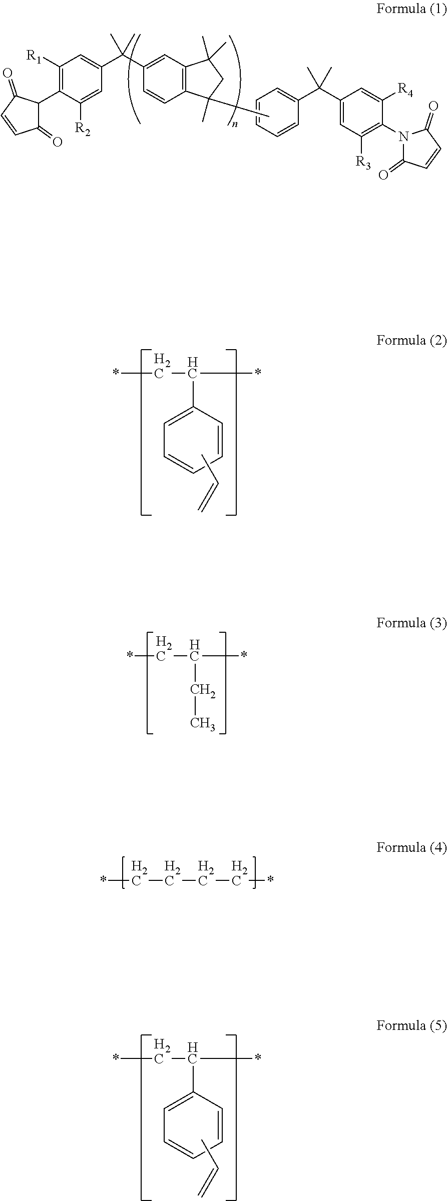

wherein n and R¹ to R⁴ are defined in the specification. The invention also provides an article manufactured using the aforesaid resin composition.

### CROSS-REFERENCE TO RELATED APPLICATIONS

This application claims the benefits of the Taiwan Patent Application Serial Number 113149097, filed on Dec. 17, 2024, the subject matter of which is incorporated herein by reference.

### BACKGROUND OF THE INVENTION

### Field

The present invention provides a resin composition and an article manufactured using the same. More specifically, the present invention provides a resin composition with improved properties and an article manufactured using the same.

### Description of Related Art

The operation of electronic equipment is achieved by connecting numerous electronic components through conductive circuits on a circuit board to provide power supply and signal transmission. A circuit board is generally composed of a circuit substrate and a conductive circuit pattern on the circuit substrate.

With the rapid development of mobile communication technology and the pursuit of lightness, thinness, compactness and high integration of current electronic devices, the corresponding circuit boards are also developing in the direction of multi-layer, high density and high transmission speed. Correspondingly, in order to ensure the quality of electronic equipment, higher requirements are placed on the comprehensive performance of circuit substrates (such as printed circuit boards). Resin composition is the basic raw material for making circuit substrates, and the design process of resin composition directly affects the performance of circuit substrates.

Therefore, how to develop a resin composition suitable for high-performance circuit substrates is currently the direction of active efforts in the industry.

### SUMMARY OF THE INVENTION

The present invention provides a resin composition, comprising: 100 parts by weight of a maleimide resin, wherein the maleimide resin comprises 50 parts by weight to 100 parts by weight of a maleimide resin represented by Formula (1); 2 parts by weight to 30 parts by weight of a polymer comprising a structural unit represented by Formula (2), a structural unit represented by Formula (5), a structural unit represented by Formula (3) and a structural unit represented by Formula (4), wherein both the structural unit represented by Formula (3) and the structural unit represented by Formula (4) are located between the structural unit represented by Formula (2) and the structural unit represented by Formula (5); and 0.5 parts by weight to 5 parts by weight of a silicon-containing compound represented by Formula (6),

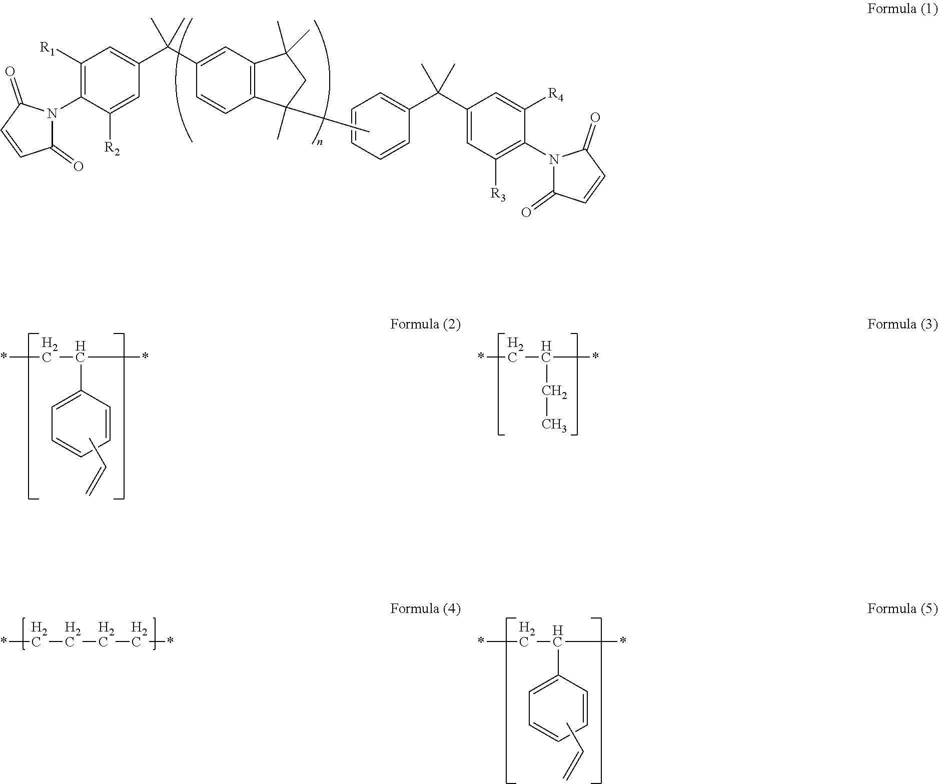

wherein,
n is a numerical average number of repeating units based on a number-average molecular weight, and is a value from 1 to 20;
each R₁, R₂, R₃ and R₄ independently is H or C₁₋₃ alkyl;

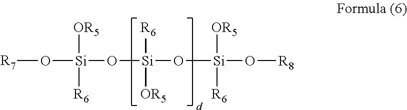

wherein,
each R₅ independently is H, methyl or ethyl, each R₆ independently is a functional group represented by Formula (7), each R₇ and R₈ independently is H, methyl or ethyl, d is a weight average number of repeating units based on a weight average molecular weight, and d is a value from 1 to 10,

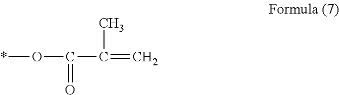

* represents a bonding position.

The present invention further comprises a resin composition, comprising: 100 parts by weight of a maleimide resin, wherein the maleimide resin comprises 50 parts by weight to 100 parts by weight of a maleimide resin represented by Formula (1); 2 parts by weight to 30 parts by weight of a polymer comprising a structural unit represented by Formula (2′), a structural unit represented by Formula (5′), a structural unit represented by Formula (3′) and a structural unit represented by Formula (4′), wherein both the structural unit represented by Formula (3′) and the structural unit represented by Formula (4′) are located between the structural unit represented by Formula (2′) and the structural unit represented by Formula (5′); and 0.5 parts by weight to 5 parts by weight of a silicon-containing compound represented by Formula (6),

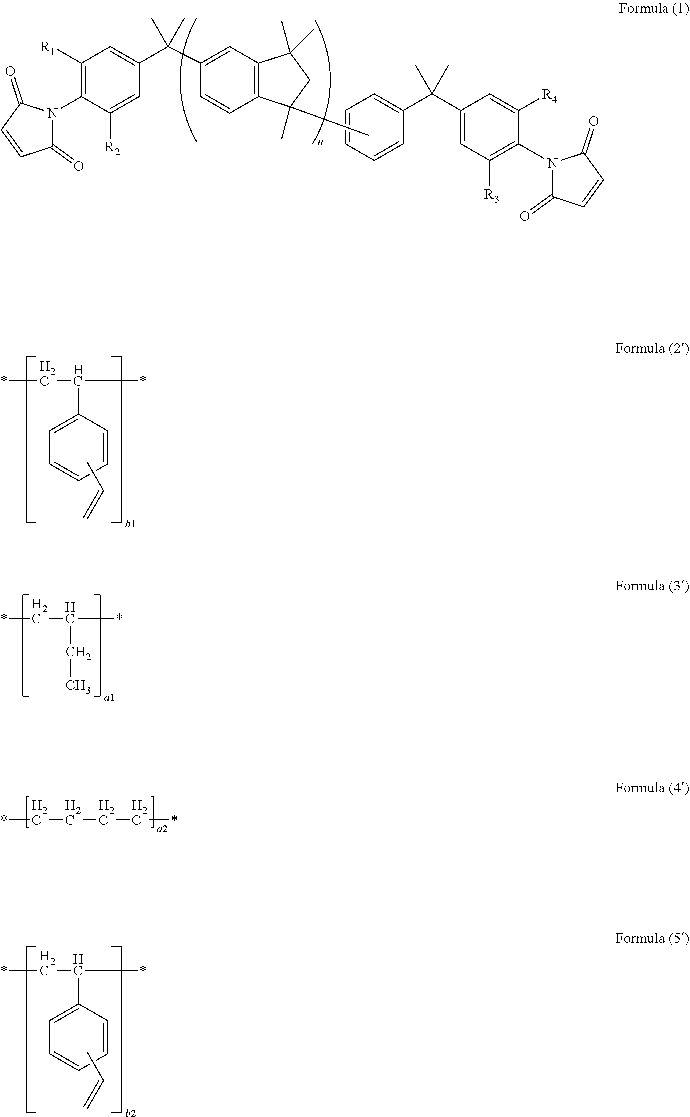

wherein,
n is a numerical average number of repeating units based on a number-average molecular weight, and is a value from 1 to 20;
each R₁, R₂, R₃ and R₄ independently is H or C₁₋₃ alkyl;
each a1 and a2 independently is 0 or a value from 1 to 398, and a1 and a2 are not 0 at the same time;
each b1 and b2 independently is a value from 1 to 398; and
a sum of a1, a2, b1 and b2 is less than or equal to 400;

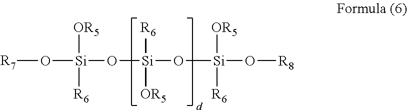

wherein,
each R₅ independently is H, methyl or ethyl, each R₆ independently is a functional group represented by Formula (7), each R₇ and R₈ independently is H, methyl or ethyl, d is a weight average number of repeating units based on a weight average molecular weight, and d is a value from 1 to 10,

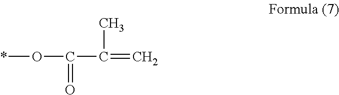

* represents a bonding position.

The present invention also provides an article manufactured using the aforesaid resin composition, wherein the article includes a prepreg, a resin film, a laminate or a printed circuit board.

The article manufactured using the resin composition of the present invention, such as a prepreg, a resin film, a laminate or a printed circuit board, has at least one excellent characteristics of the dissipation factor, the percent of thermal expansion and the glass transition temperature of the article manufactured using the resin composition of the present invention, the prepreg stickiness test and resin fill quality test of a circuit board, and therefore can be used as a high-performance laminate that meet comprehensive needs.

Other novel features of the disclosure will become more apparent from the following detailed description when taken in conjunction with the accompanying drawings.

### BRIEF DESCRIPTION OF DRAWINGS

FIG. 1 is a top view of a circuit-containing laminate 4.

FIG. 2 is a schematic view of a prepreg 3 passing a stickiness test.

FIG. 3 is a schematic view of a prepreg 3 sticking.

FIG. 4 is a side view of a varnish without phase separation.

FIG. 5 is a side view of a varnish with phase separation.

### DETAILED DESCRIPTION OF THE INVENTION

In the present specification, the term “a composition comprises A, B and C, wherein A comprises a1, a2 or a3” has the same meaning as the term “a composition comprises A, B and C, wherein A comprises a1, a2, a3 or a combination thereof”, that is “a composition comprises A, B and C, wherein A comprises a1, a2, a3, the combination of a1 and a2, the combination of a1 and a3, the combination of a2 and a3 or the combination of a1, a2 and a3.”

In the present specification, the terms “comprise”, “include”, “have”, “contain” or any other similar terms are open-ended transitional phrases. The terms “consisting of” and “consist” are closed-transitional phrases.

In the present specification, the range “10.0 to 20.0”, “10.0˜20.0”, “between 10.0 and 20.0” or “from 10.0 to 20.0” should be deemed to have been specifically disclosed all subranges such as 10.0 to 20.0, 10.0 to 11.0, 15.0 to 20.0, 11.0 to 19.0 etc.

In the present specification, the numerical values in the present invention include the range of rounding of the significant digits of the numerical values. For example, a value of 2.0 includes a range of 1.95 to 2.04.

In the present specification, “polymer” refers to a product formed by monomers through polymerization reactions. Monomers are compounds that form polymers. In the present specification, “polymer” may include homopolymer (that is a polymer formed by polymerization of a single monomer), copolymer, prepolymer, etc., but is not limited thereto. Copolymers include polymers formed by polymerization of multiple monomers such as dimers, trimers, and tetramers. For example, dimers are formed by polymerization of two different types of monomers, and trimers are formed by polymerization of three different types of monomers. Prepolymers are chemical substances produced by the polymerization of two or more compounds with a conversion rate between 10% and 90%. Polymers may also comprise oligomers. Oligomers, also known as low polymers, are polymers composed of 2 to 20 repeating units, usually 2 to 5 repeating units. For example, “diene polymer” includes diene homopolymers, diene copolymers, diene prepolymers, and the like. The term “diene polymer” also includes diene oligomers.

In the present specification, “copolymer” refers to a product formed by polymerization of two or more different monomers, including but not limited to random copolymers (having structures such as but not limied to -AABABBBAAABBA-, wherein A and B respectively represent two monomers with different chemical formulas), alternating copolymers (having structures such as but not limited to: -ABABABAB-), graft copolymers (having structures such as but not limited to:

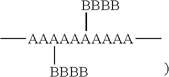

or block copolymers (having structures such as but not limited to: -AAAAA-BBBBBB-AAAAA-). For example, styrene-butadiene copolymer is formed by the polymerization of two different monomers: styrene and butadiene. For example, the styrene-butadiene copolymer includes, but is not limited to, a styrene-butadiene random copolymer, a styrene-butadiene alternating copolymer, a styrene-butadiene graft copolymer or a styrene-butadiene block copolymer. The styrene-butadiene block copolymer includes, for example, but is not limited to, a molecular structure of styrene-styrene-styrene-butadiene-butadiene-butadiene after polymerization. The styrene-butadiene block copolymer includes, for example, but is not limited to, styrene-butadiene-styrene block copolymer. The styrene-butadiene-styrene block copolymer includes, for example, but is not limited to, a molecular structure of styrene-styrene-styrene-butadiene-butadiene-butadiene-butadiene-styrene-styrene-styrene after polymerization. Similarly, the hydrogenated styrene-butadiene copolymer includes a hydrogenated styrene-butadiene random copolymer, a hydrogenated styrene-butadiene alternating copolymer, a hydrogenated styrene-butadiene graft copolymer or a hydrogenated styrene-butadiene block copolymer. The hydrogenated styrene-butadiene block copolymer includes, for example, but is not limited to, a hydrogenated styrene-butadiene-styrene block copolymer.

In the present specification, “resin” includes monomers, polymers obtained by polymerization of monomers, combinations of monomers, combinations of polymers, or combinations of monomers and polymers obtained by polymerization of monomers, and is not limited thereto. For example, in the present specification, “maleimide resin” includes maleimide monomers, maleimide polymers, combinations of maleimide monomers, combinations of maleimide polymers, or combinations of maleimide monomers and maleimide polymers.

Herein, “vinyl-containing group” includes vinyl group, vinylene group, allyl group, (methyl) acryl group or vinylbenzyl group.

In the present specification, a modified product (also referred to as a modification) includes: a product after the reactive functional groups of the resin are modified, a product after the prepolymerization reaction of the resin with other resins, a product after the copolymerization of the resin with other resins, a product after the cross-linking of the resin with other resins, a product after the self-polymerization of the resin, etc. For example, a product obtained by replacing the original terminal hydroxyl group with a terminal vinyl group through a chemical reaction is a modified product, or a product obtained by chemically reacting the original terminal vinyl group with p-aminophenol to obtain a terminal hydroxyl group is also a modified product.

In the present specification, the “unsaturated bond” described in the present invention refers to an unsaturated bond that is still reactive. For example, vinyl bonds, acetylene bonds, and vinyl bonds on methacrylates are all unsaturated bonds that are still reactive. For example, the unsaturated bond includes, but is not limited to, unsaturated double bonds that can undergo cross-linking reactions with other functional groups. For example, the unsaturated bond includes, but is not limited to, unsaturated carbon-carbon double bonds that can undergo cross-linking reactions with other functional groups.

In the present specification, the (substituent) compound represents both a compound not containing the substituent and a compound containing the substituent. For example, (meth)acrylate should be read as including acrylate and methacrylate.

In the present specification, parts by weight refers to the number of parts by weight, which can be any weight unit, such as but not limited to kilograms, grams, pounds, etc. For example, 100 parts by weight of maleimide resin means it can be 100 kilograms of maleimide resin or 100 pounds of maleimide resin. If the resin solution contains a solvent and a resin, the parts by weight of the (solid or liquid) resin generally refers to the weight unit of the (solid or liquid) resin and does not include the weight unit of the solvent in the solution, while the parts by weight of the solvent refers to the weight unit of the solvent.

One embodiment of the present invention provides a resin composition, comprising: 100 parts by weight of a maleimide resin, wherein the maleimide resin comprises 50 parts by weight to 100 parts by weight of a maleimide resin represented by Formula (1); 2 parts by weight to 30 parts by weight of a polymer comprising a structural unit represented by Formula (2), a structural unit represented by Formula (5), a structural unit represented by Formula (3) and a structural unit represented by Formula (4), wherein both the structural unit represented by Formula (3) and the structural unit represented by Formula (4) are located between the structural unit represented by Formula (2) and the structural unit represented by Formula (5); and 0.5 parts by weight to 5 parts by weight of a silicon-containing compound represented by Formula (6),

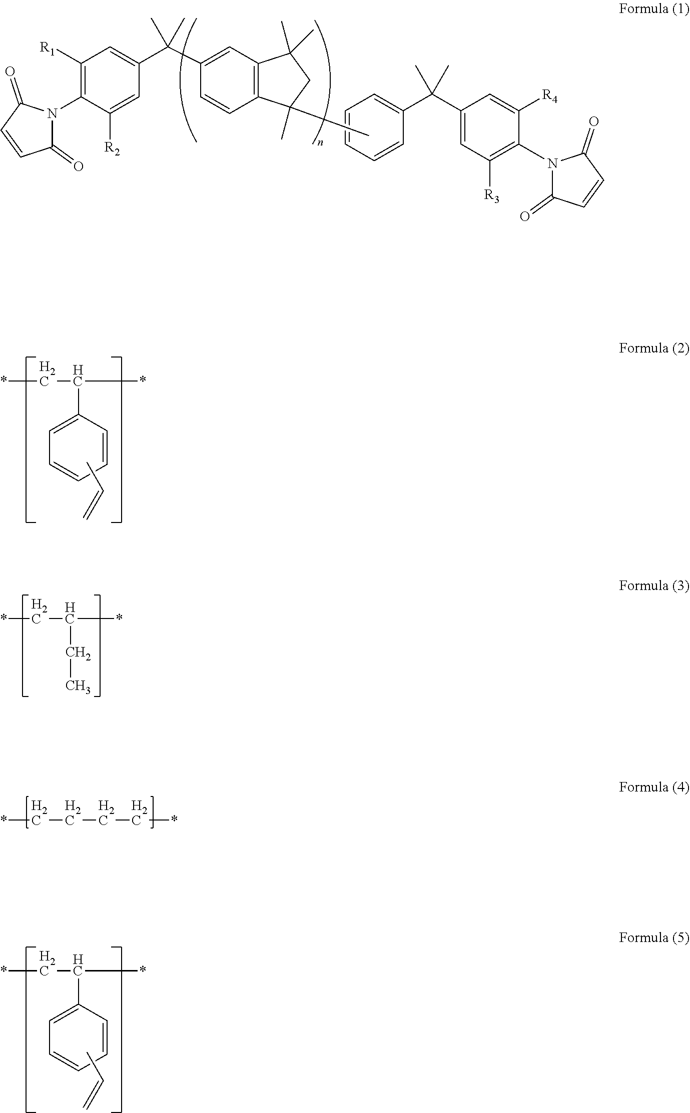

wherein,
n is a numerical average number of repeating units based on a number-average molecular weight, and is a value from 1 to 20;
each R₁, R₂, R₃ and R₄ independently is H or C₁₋₃ alkyl;

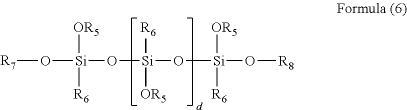

wherein,
each R₅ independently is H, methyl or ethyl, each R₆ independently is a functional group represented by Formula (7), each R₇ and R₈ independently is H, methyl or ethyl, d is a weight average number of repeating units based on a weight average molecular weight, and d is a value from 1 to 10,

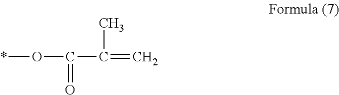

wherein * represents a bonding position.

Another embodiment of the present invention provides a resin composition, comprising: 100 parts by weight of a maleimide resin, wherein the maleimide resin comprises 50 parts by weight to 100 parts by weight of a maleimide resin represented by Formula (1); 2 parts by weight to 30 parts by weight of a polymer comprising a structural unit represented by Formula (2′), a structural unit represented by Formula (5′), a structural unit represented by Formula (3′) and a structural unit represented by Formula (4′), wherein both the structural unit represented by Formula (3′) and the structural unit represented by Formula (4′) are located between the structural unit represented by Formula (2′) and the structural unit represented by Formula (5′); and 0.5 parts by weight to 5 parts by weight of a silicon-containing compound represented by Formula (6),

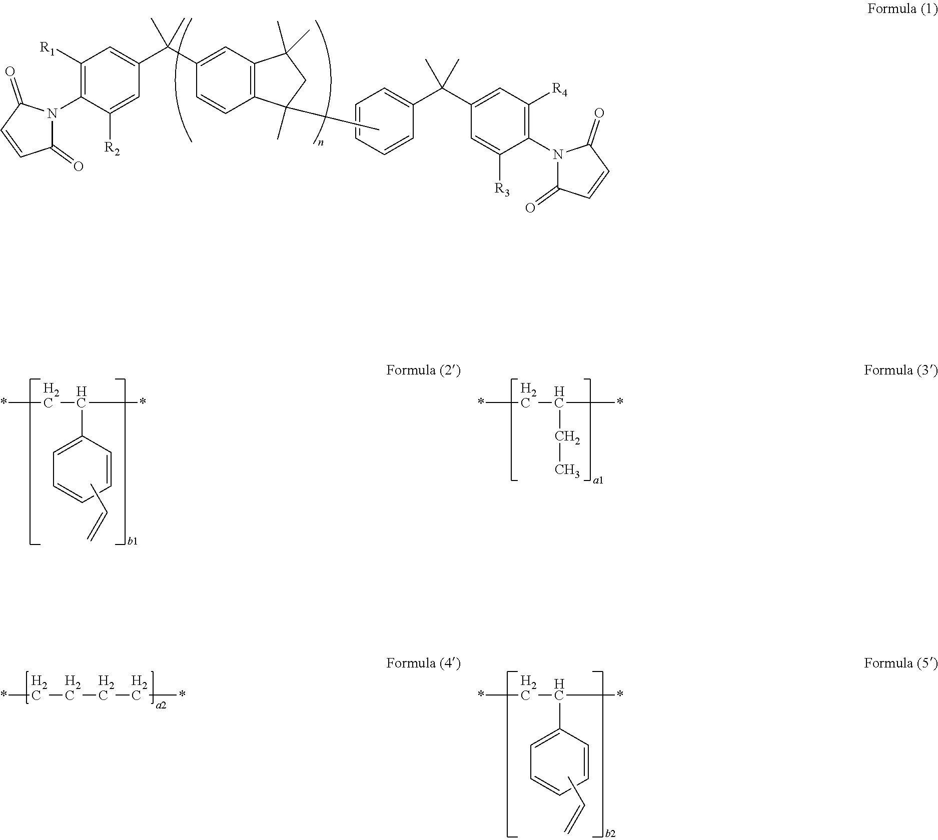

wherein,
n is a numerical average number of repeating units based on a number-average molecular weight, and is a value from 1 to 20;
each R₁, R₂, R₃ and R₄ independently is H or C₁₋₃ alkyl;
each a1 and a2 independently is 0 or a value from 1 to 398, and a1 and a2 are not 0 at the same time;
each b1 and b2 independently is a value from 1 to 398; and a sum of a1, a2, b1 and b2 is less than or equal to 400;
wherein the definition of the silicon-containing compound represented by Formula (6) is the same as described above; and
wherein * represents a bonding position.

In Formula (1), n represents the numerical average number of repeating units based on the number-average molecular weight of the structural unit in the brackets. That is, the polymerization degree n of the repeating units of the maleimide resin represented by Formula (1) is the numerical average number of repeating units calculated from the measured value of the number-average molecular weight of the maleimide resin having the structure shown in Formula (1). Therefore, n is a value from 1 to 20, n can be a positive integer from 1 to 20, and n can also be a non-integer from 1 to 20. For example, in one embodiment, n may be 1, 1.2, 2, 3, 4.5, 5, 7, 8.8, 10, 15.3, 19, 20 or 20.3, but the present invention is not limited thereto. For example, in one embodiment, the number-average molecular weight of the maleimide resin represented by Formula (1) is 1272, and the value of n is [(1272−718.94)/158.24]+1=4.50, that is, n is 4.5.

For example, in one embodiment, the maleimide resin represented by Formula (1) of the present invention may be a maleimide resin represented by Formula (1.1):

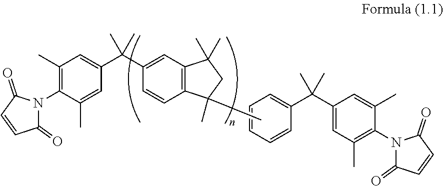

wherein n is a numerical average number of repeating units based on a number-average molecular weight, and is a value from 1 to 20.

In Formula (1.1), n represents the numerical average number of repeating units of the structural unit in the brackets based on number-average molecular weight, and n is a value from 1 to 20. For example, in one embodiment, n can be, for example, but not limited to 1, 2, 3, 3.5, 4, 4.5, 5, 7, 7.5, 8, 8.5, 10, 15, 19 or 20.

For example, in one embodiment, the maleimide resin represented by Formula (1) of the present invention may be a maleimide resin represented by Formula (1.1.1):

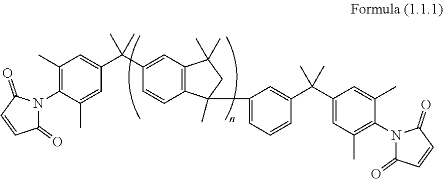

wherein n is a numerical average number of repeating units based on a number-average molecular weight, and is a value from 1 to 20.

In Formula (1.1.1), n represents the numerical average number of repeating units of the structural unit in the brackets based on number-average molecular weight, and n is a value from 1 to 20. For example, in one embodiment, n can be, for example, but not limited to 1, 2, 3, 3.5, 4, 4.5, 5, 7, 7.5, 8, 8.5, 10, 15, 19 or 20.

In the resin composition of the present invention, the structural unit represented by Formula (3) and the structural unit represented by Formula (4) in the polymer are both located between the structural unit represented by Formula (2) and the structural unit represented by Formula (5), that is, the structural unit represented by Formula (2) and the structural unit represented by Formula (5) can be located at the two outermost ends of the polymer structure, and the structural unit represented by Formula (3) and the structural unit represented by Formula (4) can be located between the structural unit represented by Formula (2) and the structural unit represented by Formula (5). The number of the structural unit represented by Formula (2), the structural unit represented by Formula (3), the structural unit represented by Formula (4) or the structural unit represented by Formula (5) may be multiple. When the structural unit represented by Formula (3) and the structural unit represented by Formula (4) are multiple, the multiple structural units represented by Formula (3) and the multiple structural units represented by Formula (4) are polymerized and arranged in the form of a random copolymer, and the above-mentioned multiple represents greater than or equal to 2. For example, the above-mentioned multiple represents greater than or equal to 2 and less than or equal to 200, but the present invention is not limited thereto.

In the resin composition of the present invention, the structural unit represented by Formula (3′) and the structural unit represented by Formula (4′) of the polymer are both located between the structural unit represented by Formula (2′) and the structural unit represented by Formula (5′), that is, the structural unit represented by Formula (2′) and the structural unit represented by Formula (5′) can be located at the two outermost ends of the polymer structure, and the structural unit represented by Formula (3′) and the structural unit represented by Formula (4′) can be located between the structural unit represented by Formula (2′) and the structural unit represented by Formula (5′). The number of the structural unit represented by Formula (2′), the structural unit represented by Formula (3′), the structural unit represented by Formula (4′) or the structural unit represented by Formula (5′) may be multiple. When the structural unit represented by Formula (3′) and the structural unit represented by Formula (4′) are multiple, the multiple structural units represented by Formula (3′) and the multiple structural units represented by Formula (4′) are polymerized and arranged in the form of a random copolymer, and the above-mentioned multiple represents greater than or equal to 2. For example, the above-mentioned multiple represents greater than or equal to 2 and less than or equal to 200, but the present invention is not limited thereto.

In the resin composition of the present invention, the weight average molecular weight of the polymer may be between 120,000 and 160,000.

In the resin composition of the present invention, the polymer may be a polymer represented by Formula (8-1):

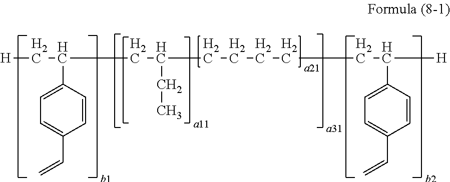

wherein, a11, a21 and a31 are weight average numbers of repeating units based on weight average molecular weight, each a11, a21 and a31 may independently be a value from 0 to 398, and a11 and a21 may not be zero at the same time; b1 and b2 are weight average numbers of repeating units based on weight average molecular weight, each b1 and b2 may independently be a value from 1 to 398, and the sum of (the sum of a11 plus a21 multiplied by the sum of a31) and (the sum of b1 and b2) may be less than or equal to 400.

In the resin composition of the present invention, the polymer may be a polymer represented by Formula (8-2):

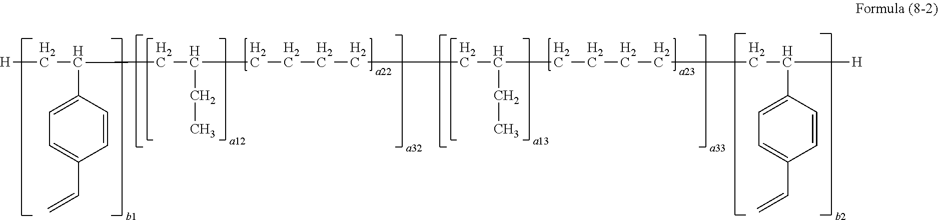

wherein, a12, a22, a32, a13, a23 and a33 are weight average numbers of repeating units based on weight average molecular weight, each a12, a22, a32, a13, a23 and a33 may independently be a value from 0 to 398, and a12, a22, a13 and a23 may not be zero at the same time; b1 and b2 are weight average numbers of repeating units based on weight average molecular weight, each b1 and b2 may independently be a value from 1 to 398, and the sum of (the sum of b1 and b2), (the sum of a12 plus a22 multiplied by the sum of a32) and (the sum of a13 plus a23 multiplied by the sum of a33) may be less than or equal to 400.

In the resin composition of the present invention, the polymer may be a divinylbenzene-terminated hydrogenated polybutadiene resin, which is commercially available, for example, from Kraton.

In the resin composition of the present invention, the silicon-containing compound represented by Formula (6) may be a silicon-containing compound represented by Formula (6-1):

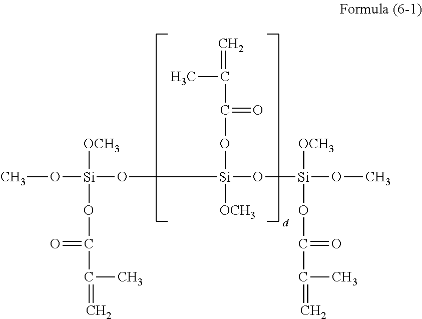

wherein, in Formula (6-1), d is the weight average number of repeating units based on the weight average molecular weight, and d may be a value from 1 to 10.

In the resin composition of the present invention, the silicon-containing compound represented by Formula (6) is commercially available, for example, from Shin-Etsu Chemical Company.

In the resin composition of the present invention, with respect to 100 parts by weight of maleimide resin, the content of the polymer comprising the structural unit represented by Formula (2), the structural unit represented by Formula (5), the structural unit represented by Formula (3) and the structural unit represented by Formula (4) may be 2 parts by weight to 30 parts by weight, for example but not limited to 2 parts by weight, 5 parts by weight, 10 parts by weight, 21 parts by weight or 30 parts by weight of the aforementioned polymer.

In the resin composition of the present invention, with respect to 100 parts by weight of maleimide resin, the content of the silicon-containing compound represented by Formula (6) may be 0.5 parts by weight to 5 parts by weight. For example, the resin composition may comprise 0.5 parts by weight, 0.8 parts by weight, 2 parts by weight, 3 parts by weight or 5 parts by weight of the silicon-containing compound represented by Formula (6), but the present invention is not limited thereto.

In one embodiment, in the resin composition of the present invention, the maleimide resin may further include other types of maleimide resins other than the maleimide resin represented by Formula (1) of the present invention, and the total amount of the other types of maleimide resins and the maleimide resin represented by Formula (1) is 100 parts by weight.

In one embodiment, the aforesaid maleimide resin may comprise 4,4′-diphenylmethane bismaleimide, polyphenylmethane maleimide (or called as oligomer of phenylmethane maleimide), bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, 1,6-bismaleimide-(2,2,4-trimethyl) hexane, N-2,3-xylylmaleimide, N-2,6-xylylmaleimide, N-phenylmaleimide, vinyl benzyl maleimide, maleimide with biphenyl structure, maleimide resin containing C₁₀₋₅₀ aliphatic structure, prepolymer of diallyl compound and maleimide resin, prepolymer of multifunctional amine and maleimide resin (herein, the multifunctional amine includes two or more amine groups), prepolymer of aminophenol and maleimide resin, or a combination thereof.

For example, other types of maleimide resin may comprise but not limited to: maleimide resin produced by Daiwakasei Industry with trade names BMI-1000, BMI-1000H, BMI-1100, BMI-1100H, BMI-2000, BMI-2300, BMI-3000, BMI-3000H, BMI-4000, BMI-5000, BMI-5100, BMI-TMH, BMI-7000 and BMI-7000H; maleimide resin produced by K.I Chemical Co., Ltd. with trade names BMI-70 or BMI-80; or maleimide resin produced by Nippon Kayaku Co., Ltd. with trade names MIR-3000 or MIR-5000.

For example, maleimide resin containing C₁₀₋₅₀ aliphatic structure may comprise but not limited to: maleimide resin containing C₁₀₋₅₀ aliphatic structure produced by Designer Molecular Co., Ltd. with trade names BMI-689, BMI-1400, BMI-1500, BMI-1700, BMI-2500, BMI-3000, BMI-5000 and BMI-6000; or maleimide resin containing C₁₀₋₅₀ aliphatic structure produced by Shin-etsu chemical co., Ltd. with trade names SLK-3000 series, SLK-1500 series and SLK-2000 series. The structure of SLK-3000 produced by Shin-etsu chemical co., Ltd. is the same as the structure of BMI-3000 produced by Designer Molecular Co., Ltd.

In one embodiment, the resin composition of the present invention may further comprise vinyl-containing polyphenylene ether resin, divinyl diphenylethane, triallyl isocyanurate, or bifunctional aliphatic long chain acrylate.

In one embodiment, the vinyl-containing polyphenylene ether resin may comprise various polyphenylene ether resins with terminals modified by vinyl or allyl groups. In addition, vinyl-containing polyphenylene ether resin may also be a polyphenylene ether resin with terminals modified by a (methyl) acryl group.

In one embodiment, the aforesaid vinyl-containing polyphenylene ether resin refers to polyphenylene ether resin with a vinyl group. The embodiments thereof may comprise, but not limited to, polyphenylene ether resins containing vinyl, allyl, vinylbenzyl or (meth)acryl groups. For example, in one embodiment, the aforesaid vinyl-containing polyphenylene ether resin comprises: vinyl benzyl biphenyl polyphenylene ether resin, (meth)acrylate polyphenylene ether resin (i.e. (meth)acryloyl polyphenylene ether resin), allyl polyphenylene ether resin, vinyl benzyl modified bisphenol A polyphenylene ether resin, vinyl chain-extended polyphenylene ether resin or a combination thereof. For example, the aforesaid vinyl-containing polyphenylene ether resin may be a vinylbenzyl biphenyl polyphenylene ether resin having a number-average molecular weight of about 1200 (e.g., OPE-2st 1200, available from Mitsubishi Gas Chemical Co., Ltd.), a vinylbenzyl biphenyl polyphenylene ether resin having a number-average molecular weight of about 2200 (e.g., OPE-2st 2200, available from Mitsubishi Gas Chemical Co., Ltd.), or a methacrylate polyphenylene ether resin having a number-average molecular weight of about 1900 to 2300 (e.g., SA9000, available from Sabic Corporation). The aforementioned vinyl chain-extended polyphenylene ether resin may include various types of polyphenylene ether resins disclosed in U.S. Patent Application Publication No. 2016/0185904 A1.

In one embodiment, the aforesaid divinyl diphenylethane may comprise p,p-divinyl-1,2-diphenylethane (p,p-BVPE, such as divinyl diphenylethane represented by Formula (9-1)), p,m-divinyl-1,2-diphenylethane (p,m-BVPE, such as divinyl diphenylethane represented by Formula (9-2)) and m,m-divinyl-1,2-diphenylethane (m,m-BVPE, such as divinyl diphenylethane represented by Formula (9-3)). Herein, p represents the para position and m represents the meta position.

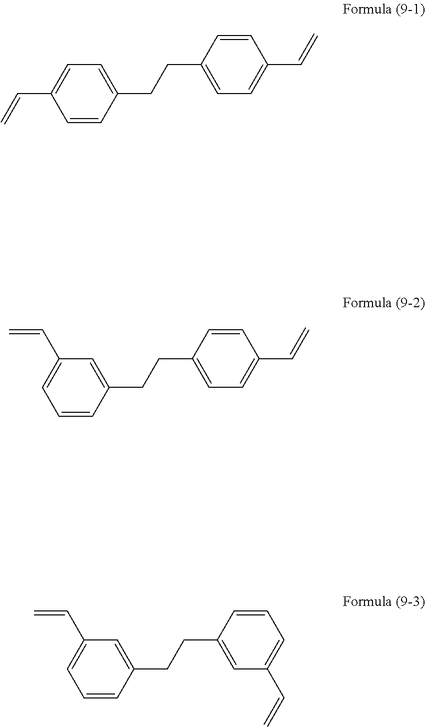

In one embodiment, with respect to 100 parts by weight of the maleimide resin, the resin composition of the present invention may further comprise 5 parts by weight to 20 parts by weight of vinyl-containing polyphenylene ether resin, divinyl diphenylethane, triallyl isocyanurate or a combination thereof, for example but not limited to, 5 parts by weight to 20 parts by weight of triallyl isocyanurate, 5 parts by weight to 20 parts by weight of vinyl-containing polyphenylene ether resin, 5 parts by weight to 20 parts by weight of triallyl isocyanurate, or 5 parts by weight to 20 parts by weight of vinyl-containing polyphenylene ether resin, divinyl diphenylethane and triallyl isocyanurate.

In one embodiment, the aforesaid bifunctional aliphatic long chain acrylate may be a bifunctional acrylate having an aliphatic long chain with a carbon number of 5 or more. For example, the bifunctional aliphatic long chain acrylate may be a compound represented by Formula (10):

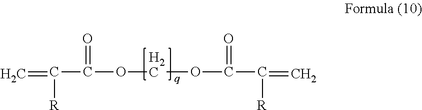

wherein, q may be an integer greater than or equal to 5, and R may be hydrogen or methyl.

In one embodiment, the q value of the bifunctional aliphatic long chain acrylate may be an integer greater than 5 and less than 20, that is, q is an integer greater than or equal to 5 and less than or equal to 20. In addition, the bifunctional aliphatic long chain acrylate has two acrylate functional groups, and the aliphatic long chain with more than 5 carbon atoms represents the value of q. For example, the aliphatic long chain with 6 carbon atoms represents that q is equal to 6.

In one embodiment, with respect to 100 parts by weight of maleimide resin, the resin composition of the present invention may further comprise 1 part by weight to 5 parts by weight of bifunctional aliphatic long chain acrylate.

In one embodiment, the resin composition may further include an inorganic filler, a curing accelerator, an inhibitor, a flame retardant, a colorant, a toughening agent, a core-shell rubber, a silane coupling agent or a solvent. The aforementioned components may be used alone or in combination.

In one embodiment, the resin composition may further comprise an inorganic filler, and the content of the inorganic filler is not limited. In another embodiment, with respect to 100 parts by weight of the maleimide resin represented by Formula (1), the resin composition may comprise 20 parts by weight to 230 parts by weight of an inorganic filler, 20 parts by weight to 210 parts by weight of an inorganic filler, 20 parts by weight to 80 parts by weight of an inorganic filler, 25 parts by weight to 135 parts by weight of an inorganic filler, 30 parts by weight to 100 parts by weight of an inorganic filler, or 30 parts by weight to 150 parts by weight of an inorganic filler. However, the present invention is not limited thereto, and the content of the inorganic filler may be adjusted according to the needs.

In one embodiment, the inorganic filler may be silicon dioxide. In one embodiment, the inorganic filler may be spherical silica. The spherical silica may include various types of spherical silica known in the art, and the particle size distribution D50 of the spherical silica may be, for example, less than or equal to 2.0 μm. For example, the particle size distribution D50 may range from 0.2 μm to 2.0 μm, for example, but not limited to 0.2 μm, 0.3 μm, 0.4 μm, 0.6 μm, 0.8 μm, 1.2 μm, 1.3 μm or 2.0 μm. For example, the particle size distribution D50 refers to the particle size corresponding to the cumulative volume distribution of fillers (such as but not limited to spherical silica) reaching 50% as measured by laser scattering. The spherical silica suitable for the present invention is not particularly limited, and may be any one or more commercially available products, such as but not limited to spherical silica purchased from Admatechs Company.

In one embodiment, the spherical silica may optionally be pretreated with siloxane if it is needed. Siloxane may comprise amino silane, epoxide silane, vinyl silane, ester silane, hydroxysilane, isocyanurate silane, methacryloxysilane or acryloxysilane. With respect to 100 parts by weight of the spherical silica, the amount of the aforesaid siloxane for pretreatment may range from 0.005 parts by weight to 0.5 parts by weight, but the present invention is not limited thereto. The amount of the siloxane is not particularly limited, and the adding amount of the siloxane may be adjusted according to the dispersion of the inorganic filler in the resin composition.

In one embodiment, the inorganic filler in the resin composition may be an inorganic filler different from spherical silica, and its content may be adjusted according to the needs.

In one embodiment, the inorganic filler other than spherical silica may include non-spherical silica (i.e., conventional irregular silica, which is not spherical), aluminum oxide, aluminum hydroxide, magnesium oxide, magnesium hydroxide, calcium carbonate, aluminum nitride, boron nitride, aluminum silicon carbide, silicon carbide, titanium dioxide, barium titanate, lead titanate, strontium titanate, calcium titanate, magnesium titanate, barium zirconate, lead zirconate, magnesium zirconate, lead zirconate titanate, zinc molybdate, calcium molybdate, magnesium molybdate, ammonium molybdate, zinc molybdate-modified talc, zinc oxide, zirconium oxide, mica, boehmite (AlOOH), calcined talc, talc, silicon nitride or calcined kaolin. In addition, except for the aforementioned non-spherical silicon dioxide, the remaining aforementioned inorganic fillers may be spherical, fibrous, plate-like, granular, flake-like or needle-like. The inorganic filler other than spherical silica can be selectively pretreated with a siloxane compound if it is needed. The examples and amounts of siloxane compounds used to pretreat inorganic fillers are as described above and are not described here again.

In one embodiment, the aforesaid curing accelerator (including a curing initiator) may include a catalyst such as a Lewis base or a Lewis acid. The Lewis base may comprise one or more of imidazole, boron trifluoride amine complex, ethyltriphenyl phosphonium chloride, 2-methylimidazole (2MI), 2-phenyl-1H-imidazole (2PZ), 2-ethyl-4-methylimidazole (2E4MI), 2-undecyl-1H-imidazole (C11Z), triphenylphosphine (TPP) and 4-dimethylaminopyridine (DMAP). The Lewis acid may include metal salt compounds such as manganese, iron, cobalt, nickel, copper and zinc salt compounds, such as metal catalysts of zinc octoate or cobalt octoate. The curing accelerator may also include a curing initiator, such as a peroxide and a carbon-carbon initiator that can generate free radicals. The curing initiator may include but is not limited to: diisopropylbenzene peroxide, tert-butyl peroxybenzoate, dibenzoyl peroxide (BPO), 2,5-dimethyl-2,5-di(tert-butylperoxy)-3-hexyne (25B), bis(tert-butylperoxyisopropyl)benzene or 2,3-dimethyl-2,3-diphenylbutane. For example, with respect to 100 parts by weight of the maleimide resin, the amount of the curing accelerator used in the present invention is not particularly limited, and may be for example 0.01 parts by weight to 2.0 parts by weight, 0.05 parts by weight to 0.5 parts by weight or 0.05 parts by weight to 0.1 parts by weight.

In one embodiment, the resin composition may further comprise an inhibitor and the amount thereof is not particularly limited.

In one embodiment, the inhibitor in the resin composition may include various molecular polymerization inhibitors or free-radical stabilized polymerization inhibitors. The molecular polymerization inhibitors may include, but are not limited to, phenolic compounds, quinone compounds, aromatic amine compounds, aromatic hydrocarbon nitro compounds, sulfur-containing compounds or variable-valent metal chlorides. For example, the molecular polymerization inhibitors may comprise, but are not limited to phenol, hydroquinone, 4-tert-butylcatechol, benzoquinone, chloranil, 1,4-naphthoquinone, trimethylquinone, aniline, nitrobenzene, Na₂S, FeCl₃, or CuCl₂. The free-radical stablized polymerization inhibitors may include, but are not limited to, 1,1-diphenyl-2-trinitrophenylhydrazine (DPPH), triphenylmethyl free radical, 2,2,6,6-tetramethyl piperidine-1-oxide or derivatives of 2,2,6,6-tetramethylpiperidine-1-oxide.

In one embodiment, the resin composition may further comprise a flame retardant. The content of the flame retardant can be adjusted according to the flame retardant requirements. For example, the resin composition may comprise 5 parts by weight to 80 parts by weight of the flame retardant, but the present invention is not limited thereto. In another embodiment, the resin composition may not contain a flame retardant, that is, the content of the flame retardant is 0 parts by weight, and herein, it means that a flame retardant is not intentionally added in the resin composition.

In one embodiment, the flame retardant in the resin composition may be a phosphorus-containing flame retardant. For example, the phosphorus-containing flame retardant may comprise ammonium polyphosphate, hydroquinone bis(diphenyl phosphate), bisphenol A bis(diphenylphosphate), tri(2-carboxyethyl)phosphine (TCEP), tris(chloroisopropyl) phosphate, trimethyl phosphate (TMP), dimethyl methyl phosphonate (DMMP), resorcinol bis(dixylenyl phosphate), RDXP (such as commercially available products PX-200, PX-201, PX-202), phosphazene (such as commercially available products SPB-100, SPH-100, SPV-100), melamine polyphosphate, 9,10-dihydro-9-oxa-10-phosphaphenanthrene-10-oxide (DOPO) and derivatives thereof (for example, di-DOPO compound) or resin thereof (for example, DOPO-HQ, DOPO-NQ, DOPO-PN, DOPO-BPN), DOPO-bonding epoxy resin, diphenylphosphine oxide (DPPO) or derivaties thereof (for example, di-DPPO compound) or resin thereof, melamine cyanurate, tri-hydroxyethyl isocyanurate or aluminum phosphinate (for example, commercially available products OP-930, OP-935). Herein, DOPO-PN is DOPO phenol novolak resin, DOPO-BPN may be DOPO bisphenol novolac resin such as DOPO-BPAN (DOPO-bisphenol A novolac), DOPO-BPFN (DOPO-bisphenol F novolac) or DOPO-BPSN (DOPO-bisphenol S novolac).

In one embodiment, the content of the coloring agent, toughening agent or core-shell rubber in the resin composition is not limited and can be adjusted according to the needs.

In one embodiment, the coloring agent of the present invention may include but is not limited to a dye or a pigment.

In one embodiment, the main function of the toughening agent is to improve the toughness of the resin composition. The toughening agent of the present invention may include but is not limited to carboxyl-terminated butadiene acrylonitrile rubber (CTBN) and other rubbers.

In one embodiment, the core-shell rubber of the present invention may include various commercially available core-shell rubbers.

In one embodiment, the silane coupling agent may include a silane compound, which may be further divided into an amino silane compound, an epoxide silane compound, a vinyl silane compound, an acrylate silane compound, a methacrylate silane compound, a hydroxy silane compound, an isocyanate silane compound, an methacryloyloxy silane compound and an acryloxy silane compound according to the type of functional groups. The content of the silane coupling agent is not particularly limited, for example but not limited to, 0.005 parts by weight to 0.5 parts by weight. In addition, the resin composition may not be added with a silane coupling agent.

In one embodiment, the main function of the solvent is to dissolve the components in the resin composition, change the solid content of the resin composition, and adjust the viscosity of the resin composition. For example, the solvent may include but is not limited to methanol, ethanol, ethylene glycol monomethyl ether, acetone, butanone (also known as methyl ethyl ketone), methyl isobutyl ketone, cyclohexanone, toluene, xylene, methoxyethyl acetate, ethoxyethyl acetate, propoxyethyl acetate, ethyl acetate, propylene glycol methyl ether, dimethylformamide, dimethylacetamide, nitrogen methyl pyrrolidone or a mixed solvent thereof. The amount of the solvent added is not particularly limited, and can be adjusted according to the required viscosity of the resin composition. If a solvent is added to the resin composition, the solvent will be volatilized and removed when the resin composition is heated at high temperature to form a semi-cured state, so there is no solvent in the prepreg or the resin film, or only a trace amount of solvent is present in the prepreg or the resin film. For example, in one embodiment, with respect to 100 parts by weight of the maleimide resin, the amount of the solvent may be, for example, 10 parts by weight to 150 parts by weight, 10 parts by weight to 130 parts by weight or 10 parts by weight to 80 parts by weight.

The resin composition of the present invention can be made into various articles by various processing methods, including but not limited to a prepreg, a resin film, a laminate or a printed circuit board.

For example, the resin composition provided by one embodiment the present invention can be used to prepare a prepreg, which may include a reinforcing material and a layered structure disposed thereon. The layered structure may be formed by heating the aforementioned resin composition to a high temperature to form a semi-cured state (B-stage). The baking temperature for preparing the prepreg may be between 120° C. and 180° C., and preferably between 130° C. and 150° C. The baking time may be 2 minutes to 6 minutes. The reinforcing material may be any one of fiber material, woven fabric, and non-woven mats, and the woven fabric preferably includes glass fiber fabric. The type of the glass fiber fabric is not particularly limited, and can be various commercially available glass fiber fabrics that can be used for printed circuit boards, such as E-type glass fiber fabric, D-type glass fiber fabric, S-type glass fiber fabric, T-type glass fiber fabric, L-type glass fiber fabric or Q-type quartz fiber fabric, wherein the types of fibers may include yarn or roving, and the form may include spread form or standard form. The non-woven mats preferably include liquid crystal resin non-woven mats or quartz non-woven mats. The liquid crystal resin non-woven mats may be, for example, polyester non-woven mats, polyurethane non-woven mats, etc., and is not limited thereto. The woven fabric may also include liquid crystal resin woven fabric, such as polyester woven fabric or polyurethane woven fabric, and is not limited thereto. The reinforcing material can increase the mechanical strength of the prepreg. In one preferred embodiment, the reinforcing material may also be selectively pretreated with a siloxane compound. After the prepreg is subsequently heated for curing (C-stage), an insulating layer can be formed.

For example, the resin composition of one embodiment of the present invention may be made into a resin film, which is obtained by heating and baking to semi-cure the resin composition. The resin composition may be selectively applied on a polyethylene terephthalate film (PET film), a polyimide film (PI film), a copper foil or a resin-coated copper foil, followed by heating and baking to semi-cure the resin composition, and the resin composition is formed into a resin film. The baking temperature for preparing the resin film may be between 110° C. to 180° C., preferably between 120° C. to 150° C. The baking time may be 2 minutes to 6 minutes.

For example, the resin composition of one embodiment of the present invention can be made into a laminate. For example, the laminate may include at least two metal foils and at least one insulating layer, and the insulating layer is disposed between the two metal foils. The insulating layer may be formed by laminating and curing the aforementioned resin composition at high temperature and under high pressure (C-stage). The suitable curing temperature may be, for example, between 200° C. and 240° C., and preferably between 210° C. and 230° C.; the curing time may be 120 minutes to 200 minutes, and preferably 140 minutes to 180 minutes; and the suitable pressure may be 400 psi to 600 psi, and preferably 450 psi to 550 psi. The insulating layer may be obtained by curing at least one prepreg or at least one resin film. The metal foil can be made of copper, aluminum, nickel, platinum, silver, gold or alloys thereof. For example, the metal foil may be a copper foil. In a preferred embodiment, the laminate is a copper-clad laminate.

For example, in one embodiment, the aforementioned laminate can be further processed into a printed circuit board after circuit processing, and the manufacturing method of the printed circuit board can be any known manufacturing method.

For example, the article manufactured by the resin composition provided by one embodiment of the present invention has at least one of the following characteristics.
a percent of thermal expansion at Z-axis is less than or equal to 1.5% measured according to a method described in IPC-TM-650 2.4.24.5; for example, the percent of thermal expansion at Z-axis is between 0.9% and 1.5%;
a DMA glass transition temperature is greater than or equal to 200° C. measured according to a method described in IPC-TM-650 2.4.24.4; for example, the DMA glass transition temperature is between 210° C. and 250° C.; a dissipation factor is less than or equal to 0.0025 measured at 10 GHz according to a method described in JIS C2565; for example, the dissipation factor is between 0.0018 and 0.0025;
passing heat resistance test after moisture absorption according to methods described in IPC-TM-650 2.6.16.1 and IPC-TM-650 2.4.23;
passing a prepreg stickiness test without stickiness through visual observation by personnel; and
passing the resin fill quality test of a circuit board.

The chemical materials used in the following Embodiments and Comparative embodiments of the present invention are as follows.

Maleimide resin A: maleimide resin represented by Formula (1.1.1) with n being 1 to 5, available from DIC Company.

Maleimide resin B: maleimide resin represented by Formula (1.1.1) with n being 6 to 10, available from DIC Company.

BMI-2300: benzyl maleimide oligomer, commercially available.

MIR-3000: biphenyl aralkyl type maleimide resin, commercially available.

MIR-5000: maleimide resin containing (methylene-phenylene-methylene) structure, commercially available.

BMI-70:3,3′-dimethyl-5,5′-diethyl-4,4′-diphenylmethane bismaleimide, commercially available.

BMI-80: bisphenol A diphenyl ether bismaleimide, commercially available.

SLK-3000: maleimide with C₁₀₋₅₀ aliphatic structure, available from Shin-etsu chemical co., Ltd.

SA9000: polyphenylene ether resin containing methacrylate, commercially available

BVPE: divinyl diphenylethane, which is a mixture of p,p-BVPE and p,m-BVPE, commercially available.

TAIC: triallyl isocyanurate, commercially available.

SR238: 1,6-hexane diacrylate, commercially available.

Polymer C: a polymer comprising a structural unit represented by

Formula (2), a structural unit represented by Formula (5), a structural unit represented by Formula (3) and a structural unit represented by Formula (4), that is, divinylbenzene-terminated hydrogenated polybutadiene resin, with a weight average molecular weight between 120,000 and 160,000, commercially available.

H1051: hydrogenated styrene-butadiene-styrene triblock copolymer, commercially available.

H1054: hydrogenated styrene-butadiene-styrene triblock copolymer, commercially available.

1,2-SBS: styrene-butadiene-styrene triblock copolymer represented by Formula (11), wherein each r1, r2, r3 and r4 independently is a value greater than or equal to 1, available from Nippon Soda.

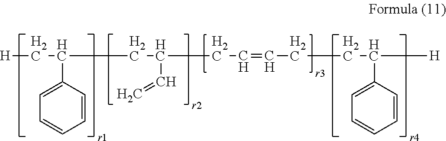

Ricon 150: polybutadiene, commercially available.

Ricon 257: styrene-butadiene-divinylbenzene terpolymer, commercially available.

Ricon 130MA13: polybutadiene adducted with maleic anhydride, commercially available.

X-40-9296: silicon-containing compound represented by Formula (6-1), wherein d is a value from 1 to 10, available from Shin-etsu chemical co., Ltd.

X-22-161A: siloxane compound with a terminal amino group, available from Shin-etsu chemical co., Ltd.

X-22-163A: siloxane compound with a terminal epoxy group, available from Shin-etsu chemical co., Ltd.

KR-511: silicon-containing compound represented by Formula (12), wherein d2 is a value between 1 and 10, available from Shin-etsu chemical co., Ltd.

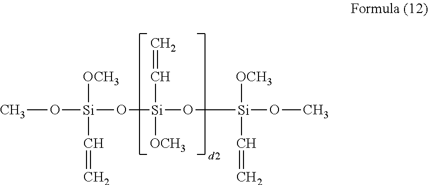

KR-513: silicon-containing compound represented by Formula (13), wherein d3 is a value between 1 and 10, available from Shin-etsu chemical co., Ltd.

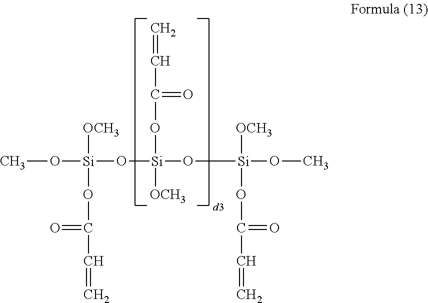

KBM-503:3-methacryloxypropyl trimethoxysilane, available from Shin-etsu chemical co., Ltd.

KBM-573: N-Phenyl-3-aminopropyl trimethoxysilane, available from Shin-etsu chemical co., Ltd.

KBM-1003: vinyl trimethoxysilane, available from Shin-etsu chemical co., Ltd.

KBM-403:3-Glycidoxypropyl trimethoxysilane available from Shin-etsu chemical co., Ltd.

C11Z: 2-undecyl imidazole, commercially available.

2Pz: 2-phenylimidazole, commercially available.

25B: 2,5-dimethyl-2,5-di(tert-butylperoxy)-3-hexyne, commercially available.

TPP: triphenylphosphine, commercially available.

SC2050 SMJ: spherical silica treated with a silane coupling agent, commercially available.

SC2050 SVJ: spherical silica treated with a silane coupling agent, commercially available.

MEK: butanone, commercially available.

Toluene: commercially available.

The various raw materials mentioned above were respectively prepared according to the amounts in Tables 1 to 5 below to prepare the resin compositions of Embodiments and Comparative embodiments of the present invention, and further prepared into various test samples. The unit of the amount of each component added in the resin composition in each Embodiments and Comparative embodiments is parts by weight, which refers to the parts by weight when the solid content of each component is 100%.

TABLE 1
The components of the resin composition of Comparative
embodiments C1 to C4 (unit: parts by weight)

| Material | Component | Name | C1 | C2 | C3 | C4 |
|---|---|---|---|---|---|---|
| Maleimide | Maleimide represented | Maleimide A | 100 | | 70 | |
| | by Formula (1) | Maleimide B | | | 30 | |
| | Aromatic maleimide | BMI-2300 | | | | |
| | | MIR-3000 | | | | |
| | | MIR-5000 | | | | |
| | | BMI-70 | | 100 | | 100 |
| | | BMI-80 | | | | |
| | Aliphatic maleimide | SLK-3000 | | | | |
| Additive 1 | Methacrylate- | SA9000 | 5 | | | 5 |
| | containing | | | | | |
| | polyphenylene ether | | | | | |
| | BVPE | BVPE | | | 5 | |
| | TAIC | TAIC | | | | |
| | Diacrylate | SR238 | | | | |
| Polyolefin | Divinylbenzene | Polymer C | | | | |
| | terminated | | | | | |
| | hydrogenated | | | | | |
| | polybutadiene | | | | | |
| | SEBS | H1051 | | | 15 | |
| | | H1054 | | 30 | | |
| | SBS | 1,2-SBS | | | | 10 |
| | Polybutadiene | Ricon 150 | | | | 1 |
| | Terpolymer | Ricon 257 | 10 | | | 2 |
| | Polybutadiene adducted | Ricon 130MA13 | | | | |
| | with maleic anhydride | | | | | |
| Silicone | Methacrylic silicone | X-40-9296 | 1.5 | 1 | 1.5 | 5 |
| | Amino silicone | X-22-161A | | | | |
| | Epoxy silicone | X-22-163A | | | | |
| | Vinyl silicone | KR-511 | | | | |
| | Acrylic silicone | KR-513 | | | | |
| Silane coupling | Methacryloxy silane | KBM-503 | | | | |
| agent | Amino silane | KBM-573 | | | | |
| | Vinyl silane | KBM-1003 | | | | |
| | Epoxy silane | KBM-403 | | | | |
| Curing | Imidazole | C11Z | 0.1 | 0.1 | 0.1 | 0.1 |
| accelerator | | 2Pz | | | | |
| | Peroxide | 25B | | | | |
| | TPP | TPP | | | | |
| Inorganic fillers | Spherical Silica | SC2050 SMJ | 100 | 100 | 100 | 100 |
| | | SC2050 SVJ | 30 | 30 | 30 | 30 |

| | | | | | |
|---|---|---|---|---|---|
| Solvent | MEK | 10 | 10 | 10 | 10 |
| | Toluene | 80 | 80 | 80 | 80 |
| Characteristics | Unit | C1 | C2 | C3 | C4 |
| Z-PTE | % | 2 | 1 | 1.5 | 1.2 |
| PCT heat resistance | N/A | Pass | Pass | Pass | Pass |
| DMA Tg | ° C. | 210 | 190 | 190 | 185 |
| Df @ 10 GHz | N/A | 0.0023 | 0.0029 | 0.0022 | 0.0029 |
| Prepreg stickiness | N/A | Sticky | Pass | Pass | Sticky |
| Prepreg shelf life | N/A | Pass | Pass | Pass | Pass |
| Varnish phase separation | N/A | Pass | Pass | Pass | Pass |
| Resin fill quality test of a circuit | N/A | Pass | Fail | Fail | Pass |
| board | | | | | |

TABLE 2
The components of the resin composition of Embodiments
E5 to E7 (unit: parts by weight)

| Material | Component | Name | E5 | E6 | E7 |
|---|---|---|---|---|---|
| Maleimide | Maleimide represented | Maleimide A | 50 | 45 | 60 |
| | by Formula (1) | Maleimide B | 50 | 5 | 10 |
| | Aromatic maleimide | BMI-2300 | | 10 | |
| | | MIR-3000 | | 10 | 15 |
| | | MIR-5000 | | 10 | |
| | | BMI-70 | | 15 | 5 |
| | | BMI-80 | | 5 | |
| | Aliphatic maleimide | SLK-3000 | | | 10 |
| Additive 1 | Methacrylate- | SA9000 | | 8 | 9 |
| | containing | | | | |
| | polyphenylene ether | | | | |
| | BVPE | BVPE | | | 5 |
| | TAIC | TAIC | | 5 | |
| | Diacrylate | SR238 | | | 3 |
| Polyolefin | Divinylbenzene | Polymer C | 30 | 20 | 20 |
| | terminated | | | | |
| | hydrogenated | | | | |
| | polybutadiene | | | | |
| | SEBS | H1051 | | | |
| | | H1054 | | | |
| | SBS | 1,2-SBS | | | |
| | Polybutadiene | Ricon 150 | | | |
| | Terpolymer | Ricon 257 | | | |
| | Polybutadiene adducted | Ricon 130MA13 | | | |
| | with maleic anhydride | | | | |
| Silicone | Methacrylic silicone | X-40-9296 | 5 | 1 | 1 |
| | Amino silicone | X-22-161A | | | |
| | Epoxy silicone | X-22-163A | | | |
| | Vinyl silicone | KR-511 | | | |
| | Acrylic silicone | KR-513 | | | |
| Silane | Methacryloxy silane | KBM-503 | | | |
| coupling | Amino silane | KBM-573 | | | |
| agent | Vinyl silane | KBM-1003 | | | |
| | Epoxy silane | KBM-403 | | | |
| Curing | Imidazole | C11Z | 0.1 | 0.05 | 0.05 |
| accelerator | | 2Pz | | 0.05 | |
| | Peroxide | 25B | | | |
| | TPP | TPP | | | |
| Inorganic | Spherical Silica | SC2050 SMJ | 100 | 10 | 210 |
| fillers | | SC2050 SVJ | 30 | 90 | 20 |

| | | | | |
|---|---|---|---|---|
| Solvent | MEK | 10 | 50 | 50 |
| | Toluene | 80 | 80 | 80 |

| Characteristics | Unit | E5 | E6 | E7 |
|---|---|---|---|---|
| Z-PTE | % | 1.5 | 0.9 | 1.3 |
| PCT heat resistance | N/A | Pass | Pass | Pass |
| DMA Tg | ° C. | 210 | 250 | 235 |
| Df @10 GHz | N/A | 0.0018 | 0.0025 | 0.0023 |
| Prepreg stickiness | N/A | Pass | Pass | Pass |
| Prepreg shelf life | N/A | Pass | Pass | Pass |
| Varnish phase separation | N/A | Pass | Pass | Pass |
| Resin fill quality test of a circuit board | N/A | Pass | Pass | Pass |

TABLE 3
The components of the resin composition of Comparative
embodiments C1 to C4 (unit: parts by weight)

| Material | Component | Name | C1 | C2 | C3 | C4 |
|---|---|---|---|---|---|---|
| Maleimide | Maleimide represented | Maleimide A | 100 | | 70 | |
| | by Formula (1) | Maleimide B | | | 30 | |
| | Aromatic maleimide | BMI-2300 | | | | |
| | | MIR-3000 | | | | |
| | | MIR-5000 | | | | |
| | | BMI-70 | | 100 | | 100 |
| | | BMI-80 | | | | |
| | Aliphatic maleimide | SLK-3000 | | | | |
| Additive 1 | Methacrylate- | SA9000 | 5 | | | 5 |
| | containing | | | | | |
| | polyphenylene ether | | | | | |
| | BVPE | BVPE | | | 5 | |
| | TAIC | TAIC | | | | |
| | Diacrylate | SR238 | | | | |
| Polyolefin | Divinylbenzene | Polymer C | | | | |
| | terminated | | | | | |
| | hydrogenated | | | | | |
| | polybutadiene | | | | | |
| | SEBS | H1051 | | | 15 | |
| | | H1054 | | 30 | | |
| | SBS | 1,2-SBS | | | | 10 |
| | Polybutadiene | Ricon 150 | | | | 1 |
| | Terpolymer | Ricon 257 | 10 | | | 2 |
| | Polybutadiene adducted | Ricon 130MA13 | | | | |
| | with maleic anhydride | | | | | |
| Silicone | Methacrylic silicone | X-40-9296 | 1.5 | 1 | 1.5 | 5 |
| | Amino silicone | X-22-161A | | | | |
| | Epoxy silicone | X-22-163A | | | | |
| | Vinyl silicone | KR-511 | | | | |
| | Acrylic silicone | KR-513 | | | | |
| Silane coupling | Methacryloxy silane | KBM-503 | | | | |
| agent | Amino silane | KBM-573 | | | | |
| | Vinyl silane | KBM-1003 | | | | |
| | Epoxy silane | KBM-403 | | | | |
| Curing | Imidazole | C11Z | 0.1 | 0.1 | 0.1 | 0.1 |
| accelerator | | 2Pz | | | | |
| | Peroxide | 25B | | | | |
| | TPP | TPP | | | | |
| Inorganic fillers | Spherical Silica | SC2050 SMJ | 100 | 100 | 100 | 100 |
| | | SC2050 SVJ | 30 | 30 | 30 | 30 |

| | | | | | |
|---|---|---|---|---|---|
| Solvent | MEK | 10 | 10 | 10 | 10 |
| | Toluene | 80 | 80 | 80 | 80 |
| Characteristics | Unit | C1 | C2 | C3 | C4 |
| Z-PTE | % | 2 | 1 | 1.5 | 1.2 |
| PCT heat resistance | N/A | Pass | Pass | Pass | Pass |
| DMA Tg | ° C. | 210 | 190 | 190 | 185 |
| Df @ 10 GHz | N/A | 0.0023 | 0.0029 | 0.0022 | 0.0029 |
| Prepreg stickiness | N/A | Sticky | Pass | Pass | Sticky |
| Prepreg shelf life | N/A | Pass | Pass | Pass | Pass |
| Varnish phase separation | N/A | Pass | Pass | Pass | Pass |
| Resin fill quality test of a circuit | N/A | Pass | Fail | Fail | Pass |
| board | | | | | |

TABLE 4
The components of the resin composition of Comparative
embodiments C5 to C8 (unit: parts by weight)

| Material | Component | Name | C5 | C6 | C7 | C8 |
|---|---|---|---|---|---|---|
| Maleimide | Maleimide represented | Maleimide A | 70 | | | |
| | by Formula (1) | Maleimide B | 30 | | | |
| | Aromatic maleimide | BMI-2300 | | 90 | | 70 |
| | | MIR-3000 | | 10 | | 30 |
| | | MIR-5000 | | | | |
| | | BMI-70 | | | 100 | |
| | | BMI-80 | | | | |
| | Aliphatic maleimide | SLK-3000 | | | | |
| Additive 1 | Methacrylate- | SA9000 | | 10 | 5 | 5 |
| | containing | | | | | |
| | polyphenylene ether | | | | | |
| | BVPE | BVPE | 5 | | | |
| | TAIC | TAIC | | | | |
| | Diacrylate | SR238 | | | | |
| Polyolefin | Divinylbenzene | Polymer C | | | 15 | |
| | terminated | | | | | |
| | hydrogenated | | | | | |
| | polybutadiene | | | | | |
| | SEBS | H1051 | 2 | | | 5 |
| | | H1054 | | | | |
| | SBS | 1,2-SBS | 2 | | | |
| | Polybutadiene | Ricon 150 | | | | |
| | Terpolymer | Ricon 257 | 10 | 6 | | |
| | Polybutadiene adducted | Ricon 130MA13 | 1 | | | |
| | with maleic anhydride | | | | | |
| Silicone | Methacrylic silicone | X-40-9296 | 2 | | | 1 |
| | Amino silicone | X-22-161A | | | | |
| | Epoxy silicone | X-22-163A | | | | |
| | Vinyl silicone | KR-511 | | | | |
| | Acrylic silicone | KR-513 | | | | |
| Silane coupling | Methacryloxy silane | KBM-503 | | | | |
| agent | Amino silane | KBM-573 | | 0.5 | | |
| | Vinyl silane | KBM-1003 | | | | |
| | Epoxy silane | KBM-403 | | | | |
| Curing | Imidazole | C11Z | 0.1 | 0.5 | 0.2 | 0.1 |
| accelerator | | 2Pz | | | | |
| | Peroxide | 25B | | | | |
| | TPP | TPP | | | | |
| Inorganic fillers | Spherical Silica | SC2050 SMJ | 100 | 100 | 100 | 100 |
| | | SC2050 SVJ | 30 | 30 | 100 | 30 |

| | | | | | |
|---|---|---|---|---|---|
| Solvent | MEK | 10 | 10 | 10 | 10 |
| | Toluene | 80 | 80 | 80 | 80 |
| Characteristics | Unit | C5 | C6 | C7 | C8 |
| Z-PTE | % | 2 | 1.1 | 0.9 | 1 |
| PCT heat resistance | N/A | Pass | Pass | Pass | Pass |
| DMA Tg | ° C. | 190 | 240 | 245 | 240 |
| Df @ 10 GHz | N/A | 0.0026 | 0.0031 | 0.0029 | 0.0031 |
| Prepreg stickiness | N/A | Sticky | Sticky | Pass | Pass |
| Prepreg shelf life | N/A | Pass | Pass | Pass | Pass |
| Varnish phase separation | N/A | Pass | Pass | Pass | Pass |
| Resin fill quality test of a circuit board | N/A | Pass | Pass | Pass | Fail |

TABLE 5
The components of the resin composition of Comparative
embodiments C9 to C12 (unit: parts by weight)

| Material | Component | Name | C9 | C10 | C11 | C12 |
|---|---|---|---|---|---|---|
| Maleimide | Maleimide represented | Maleimide A | | | | 100 |
| | by Formula (1) | Maleimide B | | | | |
| | Aromatic maleimide | BMI-2300 | 50 | 100 | 100 | |
| | | MIR-3000 | | | | |
| | | MIR-5000 | | | | |
| | | BMI-70 | 50 | | | |
| | | BMI-80 | | | | |
| | Aliphatic maleimide | SLK-3000 | | | | |
| Additive 1 | Methacrylate- | SA9000 | | | 10 | 20 |
| | containing | | | | | |
| | polyphenylene ether | | | | | |
| | BVPE | BVPE | | 5 | | |
| | TAIC | TAIC | | | | |
| | Diacrylate | SR238 | | | | |
| Polyolefin | Divinylbenzene | Polymer C | | 15 | 10 | 2 |
| | terminated | | | | | |
| | hydrogenated | | | | | |
| | polybutadiene | | | | | |
| | SEBS | H1051 | 30 | | | |
| | | H1054 | | | | |
| | SBS | 1,2-SBS | | | | |
| | Polybutadiene | Ricon 150 | | | | |
| | Terpolymer | Ricon 257 | 5 | | | |
| | Polybutadiene adducted | Ricon 130MA13 | | | | |
| | with maleic anhydride | | | | | |
| Silicone | Methacrylic silicone | X-40-9296 | | | | |
| | Amino silicone | X-22-161A | 5 | | | |
| | Epoxy silicone | X-22-163A | | | 1 | |
| | Vinyl silicone | KR-511 | | 5 | | |
| | Acrylic silicone | KR-513 | | | | 5 |
| Silane coupling | Methacryloxy silane | KBM-503 | | | 1 | |
| agent | Amino silane | KBM-573 | | | 1 | |
| | Vinyl silane | KBM-1003 | | | 1 | |
| | Epoxy silane | KBM-403 | | | 1 | |
| Curing | Imidazole | C11Z | 0.1 | 0.1 | 0.1 | 0.1 |
| accelerator | | 2Pz | | | | |
| | Peroxide | 25B | | | | |
| | TPP | TPP | | | | |
| Inorganic fillers | Spherical Silica | SC2050 SMJ | 100 | 100 | 100 | 100 |
| | | SC2050 SVJ | 30 | 30 | 30 | 30 |

| | | | | | |
|---|---|---|---|---|---|
| Solvent | MEK | 10 | 10 | 10 | 10 |
| | Toluene | 80 | 80 | 80 | 80 |
| Characteristics | Unit | C9 | C10 | C11 | C12 |
| Z-PTE | % | 1.3 | 1.2 | 1.4 | 1.7 |
| PCT heat resistance | N/A | Board | Board | Board | Board |
| | | exploded | exploded | exploded | exploded |
| DMA Tg | ° C. | 235 | 240 | 240 | 245 |
| Df @ 10 GHz | N/A | 0.0028 | 0.0027 | 0.0026 | 0.0023 |
| Prepreg stickiness | N/A | Sticky | Pass | Pass | Pass |
| Prepreg shelf life | N/A | Pass | Pass | Fail | Pass |
| Varnish phase separation | N/A | Separated | Separated | Pass | Separated |
| Resin fill quality test of a circuit board | N/A | Fail | Pass | Pass | Pass |

### Varnish

According to the amounts shown Table 1 to Table 5, the components of each Embodiments (abbreviated as E, such as E1 to E7) and Comparative embodiments (abbreviated as C, such as C1 to C12) were respectively added into the stirring tank and stirred. After mixing uniformly, the obtained resin composition was called as a varnish.

The formulation method of the resin composition of Embodiment 1 (E1) is used as an example. 100 parts by weight of maleimide A, 5 parts by weight of SA9000, 10 parts by weight of polymer C and 1.5 parts by weight of X-40-9296 were added into a stirrer containing 10 parts by weight of MEK and 80 parts by weight of toluene, followed by stirring until solid raw materials, SA9000 and polymer C were completely dissolved and all components were mixed evenly. Then, 100 parts by weight of SC2050 SMJ, 30 parts by weight of SC2050 SVJ and 0.1 parts by weight of C11Z were added, and stirred until they were mixed evenly (C11Z has to be dissolved in a suitable solvent first, for example but not limited to C11Z is dissolved in 1 parts by weight of MEK first) to obtain the varnish of the resin composition of Embodiment 1 (E1).

In addition, according to the amounts shown in Table 1 to Table 5, the varnishes of the resin compositions of Embodiments 2 to 7 (E2 to E7) and Comparative embodiments 1 to 12 (C1 to C12) were prepared with reference to the preparation method of the varnish of Embodiment 1 (E1). Herein, solid raw materials, BMI-2300, BMI-70, BMI-80, SA9000, BVPE, polymer C, H1051, H1054, C11Z, 2PZ, and TPP, have to be dissolved in a solvent completely, and the solvent may be, for example, MEK, toluenes or a mixed solvent of MEK and toluene.

With reference to the following methods, the varnishes of Embodiments 1 to 7 (E1 to E7) and Comparative embodiments 1 to 12 (C1 to C12) were used to prepare the samples (respectively including prepregs, copper-containing laminates and copper-free laminates) to be tested. Then, the characteristic analyses were performed according to the following conditions.

### Prepreg 1 (Using 1035 L-Glass Fiber Fabric)

The resin compositions in different Embodiments (E1 to E7) and Comparative embodiments (C1 to C12) listed in Table 1 to Table 5 were respectively put into an impregnation tank in batches. The glass fiber fabric (such as 1035 L-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 1 (the resin content is about 70%).

### Prepreg 2 (Using 2116 E-Glass Fiber Fabric)

The resin compositions in different Embodiments (E1 to E7) and Comparative embodiments (C1 to C12) listed in Table 1 to Table 5 were respectively put into an impregnation tank in batches. The glass fiber fabric (such as 2116 E-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 2 (the resin content is about 52%).

Prepreg 3 (using 1017 E-glass fiber fabric)

The resin compositions in different Embodiments (E1 to E7) and Comparative embodiments (C1 to C12) listed in Table 1 to Table 5 were respectively put into an impregnation tank in batches. The glass fiber fabric (such as 1017 E-glass fiber fabric) was passed through the above impregnation tank, and the resin compositions were adhered to the glass fiber fabric. After heating at 130° C. for 4 minutes, the resin compositions were turned into the semi-cured state (B-Stage) to obtain the prepreg 3 (the resin content is about 79%).

### Copper-Containing Laminate 1 (or Called as Copper-Clad Laminate 1, Which was Prepared by Laminating Two Prepregs 1)

Two reverse treated copper foils 3 (RTF3, commercially available) with a thickness of 18 μm and the same two aforementioned prepregs 1 were provided. One reverse treated copper foil 3, two prepregs 1 and one reverse treated copper foil 3 were laminated in sequence, and the lamination was performed under a vacuum condition at 500 psi and 220° C. for 150 minutes to obtain a copper-containing laminate 1.

### Copper-Free Laminate 1

The aforesaid copper-containing laminate 1 was etched to remove the copper foils on both sides to obtain a copper-free laminate 1, which was formed by laminating two prepregs 1.

Copper-Containing Laminate 2 (which was Prepared by Laminating Eight Prepregs 2)

Two reverse treated copper foils 1 (RTF1, commercially available) with a thickness of 18 μm and the same eight aforementioned prepregs 2 were provided. One reverse treated copper foil 1, eight prepregs 2 and one reverse treated copper foil 1 were laminated in sequence, and the lamination was performed under a vacuum condition at 500 psi and 220° C. for 150 minutes to obtain a copper-containing laminate 2.

### Copper-Free Laminate 2

The aforesaid copper-containing laminate 2 was etched to remove the copper foils on both sides to obtain a copper-free laminate 2, which was formed by laminating eight prepregs 2.

Copper-Containing Laminate 3 (which was Prepared by Laminating One Prepreg 3)

Two reverse treated copper foils 3 (RTF3) with a thickness of 18 μm and one prepreg 3 made by impregnating each sample to be tested (each Embodiments and Comparative embodiments) with a 1017 E-glass fiber fabric were provided, and the resin content of each prepreg 3 is about 79%. One reverse treated copper foil 3, one prepreg 3 and one reverse treated copper foil 3 were laminated in sequence, and the lamination was performed under a vacuum condition at 400 psi and 215° C. for 4 hours to obtain a copper-containing laminate 3. Herein, one prepreg 3 was cured to form an insulating layer between two copper foils, and the resin content of the insulating layer was about 79%.

### Copper-Containing Laminate 4

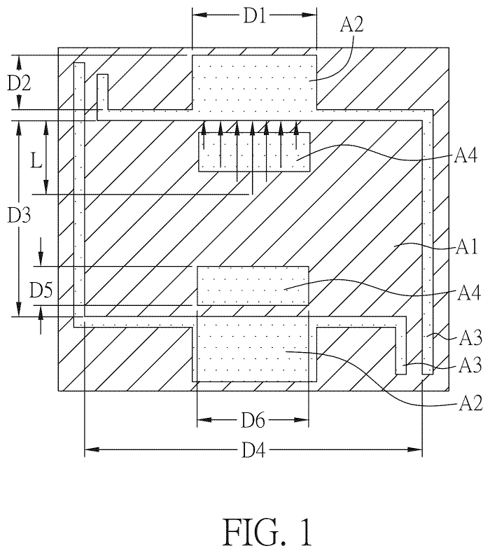

Two reverse treated copper foils 3 (RTF3) with a thickness of 18 μm, one copper-containing laminate 3 and two prepregs 3 (each Embodiments and Comparative embodiments) were provided, wherein the length of each prepreg 3 was 30 cm and the width thereof was 21 cm. The copper foils at two sides of the copper-containing laminate 3 were used to prepare the circuit regions including copper-containing regions and copper-free regions, and the circuit regions were formed by the conventional lithography and etching process. The copper foils of the copper-containing regions of the copper-containing laminate 3 were subjected to the known brown oxide treatment to obtain a brown oxide treated board. The brown oxide treated board at least comprises: a large copper region A1 treated with the brown oxide treatment and having the length D4 of 6 cm and the width D3 of 4.5 cm (as shown in FIG. 1); at least two open areas A2 without copper adjacent to the large copper region A1 (as shown in FIG. 1), wherein each open area A2 without copper has the length D1 of 2 cm and the width D2 of 1.5 cm; and at least two open areas A4 without copper inside the large copper region A1 (as shown in FIG. 1), wherein each open area A4 without copper has the length D6 of 1.5 cm and the width D5 of 0.5 cm, and the distance of the parallel gap between the open area A2 and the open area A4 is 0.1 cm (as shown in FIG. 1). One reverse treated copper foil 3, one prepreg 3, one brown oxide treated board, one prepreg 3 and one reverse treated copper foil 3 were laminated in sequence, and the lamination was performed under a vacuum condition at 400 psi and 215° C. for 4 hours to obtain a copper-containing laminate 4.

### Circuit-Containing Laminate 4

The aforesaid copper-containing laminate 4 was etched to remove the outmost copper foils on both sides to obtain a circuit-containing laminate 4.

The test methods and characteristic analysis items for the aforementioned samples to be tested are explained as follows.

### Dissipation Factor (Df)

In the measurement of the dissipation factor, one copper-free laminate 1 in each Embodiments or Comparative embodiments was provided as a sample to be tested. A microwave dielectrometer (available from Japan AET company) was used. According to the method described in JIS C2565, each sample to be tested was measured at room temperature (about 25° C.) and at a frequency of 10 GHz. The lower the dissipation factor, the better the dielectric property of the sample to be tested. Under the measurement frequency of 10 GHz and the range where the dissipation factor Df value is less than 0.0030, the difference in the Df value less than 0.0001 represents no significant difference in the dissipation factor of different laminates, and the difference in the Df value greater than or equal to 0.0001 represents a significant difference in the dissipation factor of the different laminates (there is significant technical difficulty). Under the measurement frequency of 10 GHz and the range where the dissipation factor Df value is greater than 0.0030 and less than 0.0040, the difference in the Df value less than 0.0003 represents no significant difference in the dissipation factor of the different laminates, and the difference in the Df value greater than or equal to 0.0003 represents a significant difference in the dissipation factor of the laminates (there is significant technical difficulty).

### Percent of Thermal Expansion (PTE)

A copper-free laminate 2 (prepared by laminating eight prepregs 2) was selected as the sample to be tested for thermal mechanical analysis (TMA). The copper-free laminate 2 was cut into a sample with a width of 10 mm and a length of 10 mm. The sample was heated in the temperature range from 35° C. to 300° C. at a heating rate of 10° C. per minute. The percent of thermal expansion at Z-axis (abbreviated as Z-PTE, unit: %) of each sample to be tested in the temperature range from 50° C. to 260° C. was measured according to the method described in IPC-TM-650 2.4.24.5. The lower the percent of thermal expansion, the better. When the percent of thermal expansion is less than or equal to 1.5%, the difference in the percent of thermal expansion rate greater than or equal to 0.1% is considered a significant difference, indicating a significant technical difficulty, and the difference in the percent of thermal expansion less than 0.1% is considered not significant. When the percent of thermal expansion is greater than 1.5% and less than or equal to 2.0%, the difference in the percent of thermal expansion rate greater than or equal to 0.2% is considered a significant difference, indicating a significant technical difficulty, and the difference in the percent of thermal expansion less than 0.2% is considered not significant. When the percent of thermal expansion is greater than 2.0%, the difference in the percent of thermal expansion greater than or equal to 0.3% is considered a significant difference, indicating a significant technical difficulty, and the difference in the percent of thermal expansion less than 0.3% is considered not significant. For example, the percent of expansion rate of the article made of the resin composition of the present invention measured by the method described in IPC-TM-650 2.4.24.5 is less than or equal to 1.5%, for example, between 0.9% and 1.5%.

Heat Resistance Test after Moisture Absorption (PCT Heat Resistance)

The copper-free laminate 2 was cut into a rectangular sample to be tested with a width of 12.7 mm and a length of 60 mm. Referring to the method described in IPC-TM-650 2.6.16.1, a pressure cooking test (PCT) was performed, and the sample to be tested absorbed moisture for 5 hours (the test temperature was 121° C., and the relative humidity was 100%). Then, the remaining water (if any) on the surface of the sample was removed. Referring to the method described in IPC-TM-650 2.4.23, the sample to be tested was immersed in a tin furnace with a constant temperature of 288° C., and taken out after immersing for 20 seconds to check whether there is any board explosion. For example, interlayer peeling between insulating layers is considered as board explosion, and bubbling and separation may be occurred between any layers of the laminate when interlayer peeling occurred. If the sample explodes (e.g., sample delaminates), it is marked as “board exploded”, and if the sample does not explode, it is marked as “pass”.

### Glass Transition Temperature (Tg)

In the glass transition temperature test, the above-mentioned copper-free laminate 2 was used as the sample to be tested. The dynamic mechanical analysis (DMA) was used to measure the glass transition temperature (unit: ° C.) of the sample to be tested according to the method described in IPC-TM-650 2.4.24.4. The measurement temperature range was 35° C. to 270° C., and the temperature rising rate was 2° C./min. The higher the glass transition temperature, the better the properties. The difference in glass transition temperature greater than or equal to 5° C. is a significant difference, indicating a significant technical difficulty. The difference in glass transition temperature less than 5° C. is not a significant difference. According to the results of the dynamic mechanical analysis, the glass transition temperature of the samples to be tested in Embodiments (E1 to E7) is greater than or equal to 200° C.

### Prepreg Stickiness Test

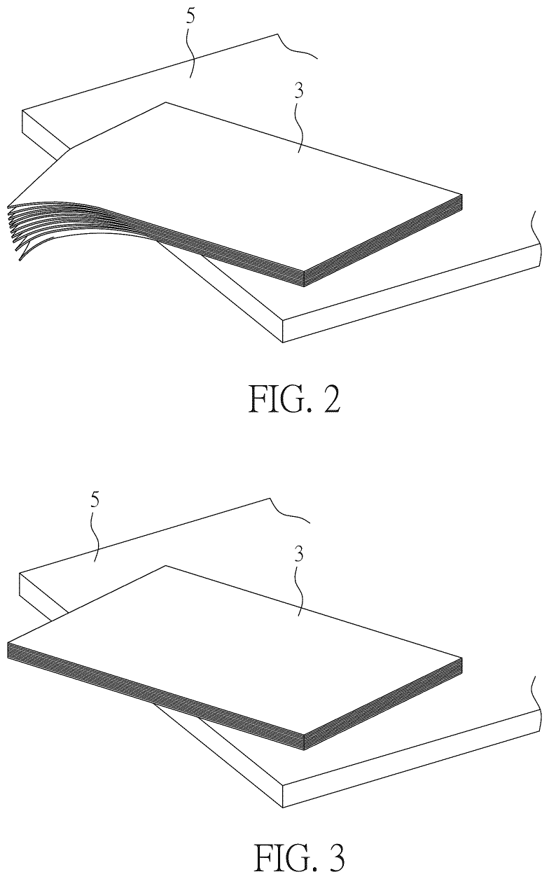

In the prepreg stickiness test, the above-mentioned prepreg 3 was selected as the sample to be tested. Ten prepregs 3 of the same Embodiment or the same Comparative embodiment were prepared and cut into squares with a length and width of 16 inches. The ten prepregs 3 were stacked into a stack (stack neatly so that the edges of the ten prepregs overlap), and put into an aluminum foil bag. The aluminum foil bag was evacuated, and then the aluminum foil bag (the vacuum-packed sample) was placed in a constant temperature and humidity chamber (the temperature was set at 45° C., and the humidity was not controlled) for heat treatment at a constant temperature of 45° C. for 24 hours. Then, the stack of ten prepregs 3 was taken out, and three corners of the stack of ten prepregs 3 were placed on the table (close to the edge of the table), and the fourth corner of the stack of ten prepregs 3 were suspended outside the table. Then, a person visually observed whether the prepregs 3 of the one corner of the stack of ten prepregs 3 suspended outside the table can be separated naturally (separated naturally within 1 minute). If each prepreg 3 can be separated naturally, it is judged that this group of samples is not sticky and marked as “pass” test, as shown in FIG. 2. On the contrary, if the prepregs 3 of the one corner of the stack of ten prepregs 3 of a sample suspended outside the table are stuck together and cannot be separated naturally (any two adjacent prepregs 3 cannot be separated naturally within one minute), then this group of samples is judged to be sticky (stickiness) and is marked as “sticky”, as shown in FIG. 3.

### Prepreg Shelf Life Test

In the prepreg shelf life test, prepregs 3 of different Embodiments (E1 to E7) and Comparative embodiments (C1 to C10) were prepared respectively. One prepreg 3 was cut into eight square pieces of 102±0.25 mm in length and 102±0.25 mm in width. Four of the pieces were stacked into a sample (edge-aligned and overlapped), and the initial weight of the sample was measured and recorded as the initial weight W₀. The sample was placed in a drying oven (23° C., relative humidity about 30%) for 4 hours, and then takeen out. A mirror steel plate, a release film, a sample (four stacked prepregs 3), a release film, and a mirror steel plate were laminated to form a lamination. A laminating machine was used to press the above lamination at a pressing temperature of 171±3° C. and a pressing pressure of 1380±70 kPa for 5 minutes, and then the lamination was taken out and cooled to room temperature. A circular punch was used to cut a disc sample with a diameter of 81.1 mm from the center of the sample, the weight of the disc sample was weighed and recorded, and the obtained weight was recorded as the disc weight W_{D}. The resin flow (RF) is calculated as follows:

RF (%)=[(W₀−2W_{D})/W₀]*100(%)

wherein, the resin flow RF value of the above sample is recorded as RF1. In addition, the other four square prepreg 3 pieces were placed in a storage environment at a temperature of 23° C. and a relative humidity of 40% for half a year. After half a year, the samples that had been placed for half a year were measured again in the same manner as above. The resin flow RF value of the samples that had been placed for half a year was recorded as RF2, and ΔRF=RF1−RF2 was calculated. When ΔRF≤±6%, it was recorded as “pass” shelf life test. When ΔRF>±6%, it was recorded as “fail” shelf life test.
Varnish Phase Separation Test (Varnish without Inorganic Filler and Curing Accelerator)

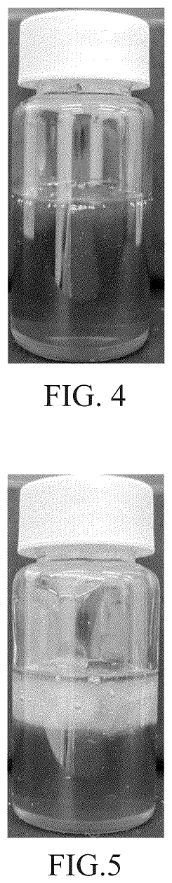

In the varnish phase separation test, varnishes of different Embodiments (E1 to E7) and Comparative embodiments (C1 to C12) were first prepared. The varnishes in this test did not contain inorganic fillers and curing accelerators. Take Embodiment 1 as an example. 100 parts by weight of maleimide A, 5 parts by weight of SA9000, 10 parts by weight of polymer C and 1.5 parts by weight of X-40-9296 were added into a stirred containing 10 parts by weight of MEK and 80 parts by weight of toluene, followed by stirring until solid raw materials, SA9000 and polymer C were completely dissolved and all components were mixed evenly, to obtain a varnish sample of the resin composition of Embodiment 1 (E1) (without inorganic filler and curing accelerator). Similarly, the varnish samples of Embodiments (E2 to E7) and Comparative embodiments (C1 to C12) (without inorganic filler and curing accelerator) were prepared, and the solid raw materials, BMI-2300, BMI-70, BMI-80, SA9000, BVPE, polymer C, H1051, and H1054 have to be completely dissolved in the solvent. 8 ml of each sample of the aforesaid Embodiments (E1 to E7) and Comparative embodiments (C1 to C12) was placed in a 10 ml transparent glass bottle, and placed at room temperature (25° C.˜27° C., relative humidity 40%˜60%) for 24 hours. Then, the varnish in the sample was visually observed to see if phase separation occurred. If the varnish in the sample presents a single phase without phase separation, it is marked as “pass”, as shown in FIG. 4. If the varnish in the sample presents at least two phases with phase separation, it is marked as “separated”, as shown in FIG. 5.

### Resin Fill Quality Test of a Circuit Board

In the resin fill quality test of a circuit board, please refers to FIG. 1. In the resin fill quality test of the prepreg, the aforesaid circuit-containing laminate 4 was used. The tester used an optical microscope to observe whether the insulating layer on the large copper region A1 (including the open area A4 and/or the open area A2) of the circuit-containing laminate 4 has glue flow marks (as indicated by the arrow, the glue flow mark is the flow mark with abnormal appearance and color caused by the uneven flow when the resin flows). When there are glue flow marks on the large copper region A1 (including the open area A4 and/or open area A2) of the circuit-containing laminate 4, the farthest distance of the glue flow mark is measured. For example, the maximum distance of the glue flow mark compared to the glue flow mark in the adjacent open area A2 is measured and defined as the flow mark length L. Herein, the flow mark length L less than 2 mm (millimeter) is grade 1, the flow mark length L greater than or equal to 2 mm and less than 5 mm is grade 2, the flow mark length L greater than or equal to 5 mm and less than 10 mm is grade 3, the flow mark length L greater than or equal to 10 mm is grade 4, and the flow mark length L covering the entire large copper region A1 is grade 5. If there is no glue flow mark on the large copper region A1 (including the open area A4 and/or the open area A2), the grade is 0. The grade 0 to grade 2 of the glue flow marks is within the acceptable range, and it will be marked as “pass” if the test result is level 0 to level 2. The grade 3 to grade 5 of the glue flow marks is in the unacceptable range, and the circuit-containing laminates with the grade 3 to grade 5 of the glue flow marks has to be discarded. If the test result is level 3 to level 5, it will be marked as “fail”. In FIG. 1, the circuit-containing laminate 4 further comprises glue overflow port A3, which is the conventional technology for the printed circuit boards. When the copper-containing laminate 4 is laminated, the resin composition of the prepreg 3 will flow from the large copper region A1 to the open area A2 and the open area A4 without copper. If the flow of the resin composition is uniform during filling, no glue flow mark is occurred. If the flow of the resin composition is uneven during filling, glue flow marks will occur. When the scanning electron microscope is used to observe the glue flow mark area of the section sample, it can be found that the inorganic filler and the insoluble flame retardant in the insulating layer are not evenly distributed in the glue flow mark area. On the contrary, it can be found that the inorganic filler and the insoluble flame retardant in the insulating layer are uniformly distributed (uniformly dispersed) in the area without the glue flow mark of the section sample.

Referring to the test results in Tables 1 to 5, it can be found that all Embodiments (E1 to E7) made of the resin composition of the present invention passed the above test. However, among Comparative embodiments (C1 to C12), Comparative embodiments C1 to C6 and Comparative embodiments C8 to C12 failed to completely pass the above test, and the dissipation factor of Comparative embodiment C7 deteriorated to 0.0029.

According to the above embodiments, the articles made of the resin composition of the present invention, such as a prepreg, a resin film, a laminate or a printed circuit board, have excellent characteristics in at least one of the dissipation factor, thermal expansion coefficient, heat resistance test after moisture absorption, glass transition temperature, prepreg stickiness test, prepreg shelf life test, varnish phase separation test and resin fill quality test of a circuit board of the articles made of the resin composition of the present invention, and thus can become a high-performance laminate that meets comprehensive requirements.

The above embodiments are essentially only auxiliary descriptions, and are not intended to limit the embodiments of the subject matter of the application or the applications or uses of these embodiments.

Although the present disclosure has been explained in relation to its embodiment, it is to be understood that many other possible modifications and variations can be made without departing from the spirit and scope of the disclosure as hereinafter claimed.

1. A resin composition, comprising:
100 parts by weight of a maleimide resin, wherein the maleimide resin comprises 50 parts by weight to 100 parts by weight of a maleimide resin represented by Formula (1);
2 parts by weight to 30 parts by weight of a polymer comprising a structural unit represented by Formula (2), a structural unit represented by Formula (5), a structural unit represented by Formula (3) and a structural unit represented by Formula (4), wherein both the structural unit represented by Formula (3) and the structural unit represented by Formula (4) are located between the structural unit represented by Formula (2) and the structural unit represented by Formula (5); and
0.5 parts by weight to 5 parts by weight of a silicon-containing compound represented by Formula (6), 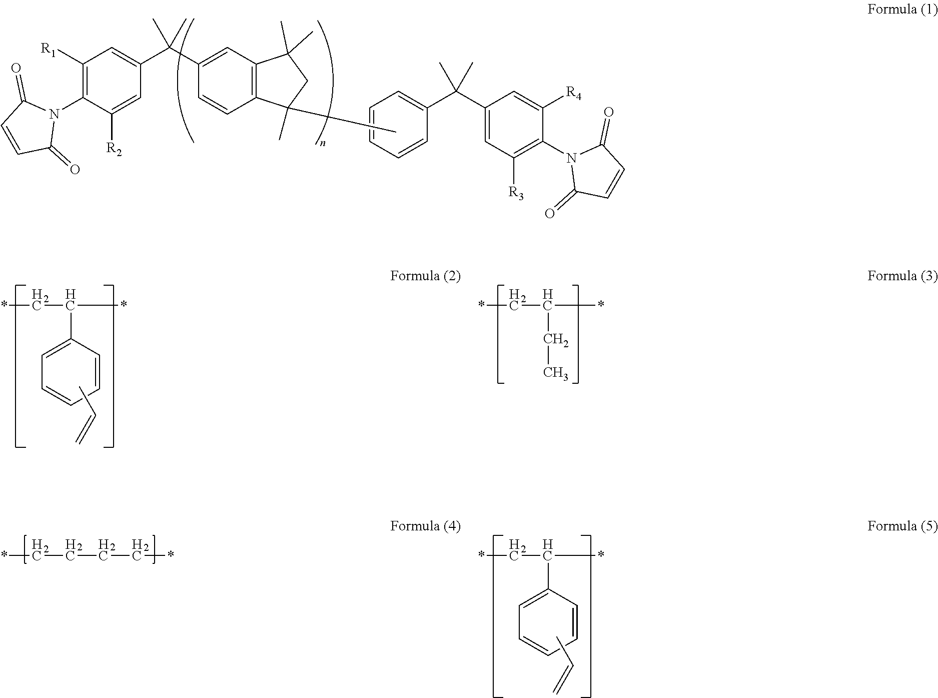
wherein,
n is a numerical average number of repeating units based on a number-average molecular weight, and is a value from 1 to 20;
each R₁, R₂, R₃ and R₄ independently is H or C₁₋₃ alkyl; 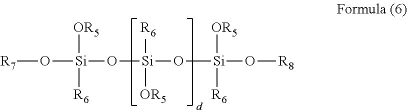
wherein,
each R₅ independently is H, methyl or ethyl, each R₆ independently is a functional group represented by Formula (7), each R₇ and R₈ independently is H, methyl or ethyl, d is a weight average number of repeating units based on a weight average molecular weight, and d is a value from 1 to 10, 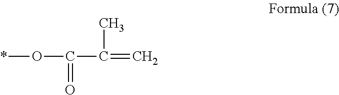
represents a bonding position.

2. The resin composition of claim 1, wherein the maleimide resin represented by Formula (1) is a maleimide resin represented by Formula (1.1): 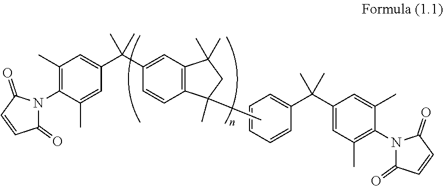
wherein n is a numerical average number of repeating units based on a number-average molecular weight, and is a value from 1 to 20.

3. The resin composition of claim 1, wherein the maleimide resin represented by Formula (1) is a maleimide resin represented by Formula (1.1.1): 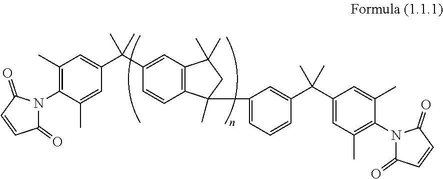
wherein n is a numerical average number of repeating units based on a number-average molecular weight, and is a value from 1 to 20.

4. The resin composition of claim 1, wherein a weight average molecular weight of the polymer ranges from 120,000 to 160,000.

5. The resin composition of claim 1, wherein the silicon-containing compound represented by Formula (6) is a silicon-containing compound represented by Formula (6-1): 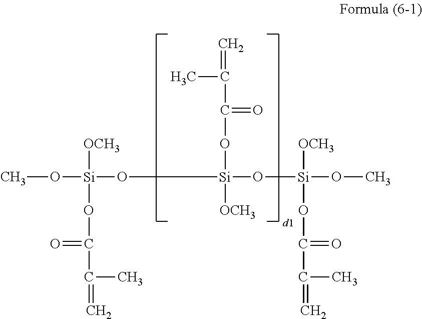
wherein d1 is a weight average number of repeating units based on a weight average molecular weight, and is a value from 1 to 10.

6. The resin composition of claim 1, further comprising: vinyl-containing polyphenylene ether resin, divinyl diphenylethane, triallyl isocyanurate, bifunctional aliphatic long chain acrylate or a combination thereof.

7. An article manufactured using the resin composition of claim 1, wherein the article includes a prepreg, a resin film, a laminate or a printed circuit board.

8. The article of claim 7, which has at least one of the following characteristics:
a percent of thermal expansion at Z-axis is less than or equal to 1.5% measured according to a method described in IPC-TM-650 2.4.24.5;
a DMA glass transition temperature is greater than or equal to 200° C. measured according to a method described in IPC-TM-650 2.4.24.4;
a dissipation factor is less than or equal to 0.0025 measured at 10 GHz according to a method described in JIS C2565; and
passing heat resistance test after moisture absorption according to methods described in IPC-TM-650 2.6.16.1 and IPC-TM-650 2.4.23.

9. The article of claim 7, which has the following characteristic:
passing a prepreg stickiness test without stickiness through visual observation by personnel.
